(19) United States
(12) Patent Application Publication
(10) Pub. No.: US 2026/0012278 A1
(43) Pub. Date: Jan. 8, 2026

(54) WIRELESS LATENCY SHIFT KEYING

(71) Applicant: Brigham Young University, Provo, UT (US)

(72) Inventors: Philip Brandon Lundrigan, Orem, UT (US); Jacob Edward Johnson, American Fork, UT (US)

(21) Appl. No.: 19/254,609

(22) Filed: Jun. 30, 2025

Related U.S. Application Data
(60) Provisional application No. 63/666,986, filed on Jul. 2, 2024.

(51) Int. Cl. H04J 13/10; H04J 3/06; H04L 5/00; H04W 24/08

(52) U.S. Cl. CPC H04J 13/10; H04J 3/0602; H04L 5/0053; H04W 24/08

(57) ABSTRACT

A wireless network includes a wireless transmitter to multiply data bits with a spreading code to generate spread data, prepend a synchronization word, and transmit a pair of null frames via an anchor wireless device to jam a ping reflector device for each chip of a one value being transmitted. A receiver transmits, via the anchor wireless device, a ping packets to the ping reflector device at a particular ping rate and receives ping acknowledgement packets from the ping reflector device in response to the transmitted ping packets. Each pair of null frames causes a spike in the ping acknowledgment packets that are received, indicating receipt of a chip of the one value. In response to correlating the synchronization word within ones of the ping acknowledgment packets, the receiver begins use of the spreading code to decode the spread data encoded within subsequently received ones of the ping acknowledgement packets.

### RELATED APPLICATIONS

This application claims, under 35 U.C.S.C. § 119 (c), priority to U.S. Provisional Patent Application No. 63/666,986, filed Jul. 2, 2024, which is incorporated by this reference in its entirety.

### STATEMENT REGARDING FEDERALLY SPONSORED RESEARCH

This invention was made with government support under contract number 2153317 awarded by the National Science Foundation (NSF). The government has certain rights in the invention.

### TECHNICAL FIELD

The present disclosure generally relates to securing wireless networks. More specifically, the present disclosure relates to employing wireless latency shift keying (LSK) to secure a wireless network from untrusted wireless devices.

### BACKGROUND

Low-cost Internet of Things (IoT) devices are plagued with security issues, especially in homes where best security practices are not always followed. Such IoT devices have been used as backdoors into private networks and utilized as botnets in massive distributed denial-of-service (DDOS) attacks. As the number of IoT devices deployed increases, which is forecasted, this problem will grow even worse.

Such attacks are possible in part because of the design of Wi-Fi™ and other wireless security. Traditionally, when one connects a device to a Wi-Fi™ network by providing a network name and password, this gives the device full access to the network. Thus, one unsecure device can compromise a whole network. Wi-Fi™, however, has only two modes of trust: complete trust or complete untrust, which excludes the possibility of partial trust of the device.

Many IoT sensors, such as temperature sensors or air quality sensors, do not require all the capabilities of Wi-Fi™ and should not get full access to a Wi-Fi™ network to periodically send small amounts of data. This coarse-grain access control is akin to having a stranger come to your house and having only two options. One option is to not answer the door. The other operation is to answer the door and give the person the keys to your house. Regrettably, partial trust or partial communication is not possible with standard Wi-Fi™.

### BRIEF DESCRIPTION OF THE DRAWINGS

Aspects, implementations, and embodiments of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a schematic block diagram of an example wireless network functioning with latency shift keying (LSK) according to some embodiments of the present disclosure.

FIG. 2 is a graph of an example of encoding data into the latency of the wireless network in accordance with some embodiments.

FIG. 3 is a graph illustrating round trip time (RTT) between wireless devices (e.g., node 1 and node 2) with null frames directed only at jamming node 1 according to some embodiments.

FIG. 4A is a graph illustrating the impact of network latency from injecting a pair of null frames into the wireless network from a latency domain perspective in accordance with some embodiments.

FIG. 4B is a graph illustrating the impact of the injecting the pair of null frames (as in FIG. 4A) from a number of pings received per millisecond perspective, according to some embodiments.

FIG. 5 is a schematic block diagram illustrating the interactions, through an anchor wireless device, between a wireless transmitter device and a receiver device operating a local LSK network to securely send IoT-related data according to some embodiments.

FIG. 6 is a schematic block diagram similar to that of FIG. 1, illustrating a bootstrapping procedure through which the wireless transmitter device identifies the anchor wireless device and the receiver device with which to communicate over the local LSK network according to some embodiments.

FIG. 7A is a flow chart of a method for leveraging LSK, imposed by injecting null frames, to communicate data from the wireless transmitter device to the receiver device according to some embodiments.

FIG. 7B is a flow chart of a method of the receiver device correlating ping acknowledgement packet spikes with the synchronization word followed by decoding the spread data using the spreading code according to some embodiments.

FIG. 8A is a flow chart of a method of the wireless transmitter device encoding spread spectrum chips, which represent data and are transmitted via null frames that generate detectable latency in the wireless network according to some embodiments.

FIG. 8B is a flow chart of a more-detailed method of employing a pseudo-random (PN) code to encode the data into spread spectrum chips and how each chip can be transmitted via use of null frames according to some embodiments.

FIG. 9 is a flow chart of a method to be executed by a state machine of the wireless transmitter device to control timing of transmitting each pair of null frames, relative to beacon frames, to encode a chip of the spread data according to some embodiments.

FIG. 10 is a graph illustrating the effect of network congestion on the bit error rate (BER) of LSK communication according to some embodiments.

FIG. 11A is a graph illustrating measured change in the average network latency of the experimental LSK network according to some embodiments.

FIG. 11B is a graph illustrating measured changes in transport control protocol (TCP) packets received per second as a result of a single LSK transmission according to some embodiments.

FIG. 12 is a graph illustrating the effect of executing the LSK network and associated software on LSK-programmed devices to an idle network according to some embodiments.

FIG. 13 is a graph illustrating the effect of range between the wireless transmitter device and the anchor wireless device on the BER according to some embodiments.

FIG. 14 is a graph illustrating the effect of increasing the number of parallel LSK devices on the BER according to some embodiments.

FIG. 15 is a schematic diagram of an example wireless device, which can represent any of the wireless devices described herein according to various embodiments.

FIG. 16 depicts a block diagram of an example computer device capable of performing the operations of any of the wireless devices as disclosed herein according to various embodiments.

### DETAILED DESCRIPTION

Aspects and implementations of the present disclosure address the above deficiencies (i.e., the lack of partial trust or partial communication with standard Wi-Fi™), among others that will be discussed, by providing systems and methods that use wireless latency shift keying (LSK) to secure a wireless network from untrusted wireless devices, such as IoT devices. More specifically, this disclosure describes ways of communicating between unassociated wireless devices and a trusted wireless network (e.g., based on Wi-Fi™) without connecting the unassociated wireless devices to the network.

In various embodiments, the described solutions require no additional hardware or changes to existing hardware, but can be implemented in software and with standard Wi-Fi™ protocol operating throughout the wireless network. These embodiments may create an air gap for safety between an untrusted IoT sensor and a secured wireless network, allowing communication to only go one direction and only when the trusted wireless network needs to receive data. The described embodiments limit the ability of a compromised wireless device to affect the secured network. For example, the disclosed LSK network approach adds a secondary form of communication to Wi-Fi™ (akin to a new wireless protocol) that is designed for IoT sensor readings that have a different security association than standard Wi-Fi™.

Other solutions exist, such as network partitioning using separate wireless networks, providing some of the same benefits. However, these solutions have significant drawbacks, such as requiring additional hardware or advanced network configuration of a wireless network and advanced knowledge of network operation, which makes it challenging to deploy to an application for a typical consumer. Disclosed solutions, however, require no additional hardware while still utilizing the main wireless (e.g., Wi-Fi™) network, making it very easy to use. A user of the disclosed system does not have to configure or adjust anything about their wireless network, as the LSK network can be viewed as an overlay on top of their existing wireless network.

One conventional way of preventing an untrusted device from compromising a network is to create two networks: one network for untrusted devices and another for trusted devices. A network manager sets up a wireless network with two advertised service set identifiers (SSIDs). Traffic coming from the different SSIDs are tagged with separate virtual local area network (VLAN) tags, preventing traffic from mixing. The separate VLANs prevent untrusted devices from accessing the trusted devices. Even if an untrusted device does get compromised, the untrusted device will only be able to affect the devices on its same network, limiting the scope of an attack.

The drawback to the above approach is that it requires a network setup that is not feasible for a typical consumer. Some consumer-grade Wi-Fi™ equipment cannot broadcast multiple SSIDs and most cannot perform VLAN tagging. Even if the hardware is capable, it requires advanced networking knowledge to set up and maintain. Since applications on a network typically do not have access to modify the configuration of the anchor wireless device, it is difficult to abstract away this complexity from the user through automation. Using this approach takes additional effort and configuration to prevent devices from accessing the Internet; otherwise, the device is still vulnerable to attacks. Even with the untrusted devices partitioned to a separate network, a device can still be used as a botnet node in a DDOS. Also, this solution is error-prone. If a user forgets to use the special untrusted network to connect a device, then the whole network can be compromised. Lastly, researchers have shown that monitoring wireless signals can determine behavior in a home. If a compromised device is allowed to connect to the Internet, the device can still cause damage or invade privacy, even if it cannot access your protected network. While all of these problems can be overcome through network configuration, they cannot be automated and require much work and configuration from the user.

The disclosed embodiments do not suffer from the same problems. These embodiments create a communication channel on top of the existing Wi-Fi™ network, requiring little setup or hardware. For example, the disclosed embodiment can be implemented using the disclosed software application and does not require direct access to the networking stack or the ability to modify access point configuration. As a result, disclosed solutions excel in deployability, meaning that the LSK network technology can be easily automated by the user applications. Each untrusted device creates a unique communication channel with a node on the trusted network. The communication channel allows each device to set up its own security association with the node on the trusted network, partitioning each untrusted device into its own virtual network. The disclosed embodiments, therefore, create an air gap between the untrusted device and the rest of the secure wireless network, preventing the untrusted device from connecting to the Internet or communicating with the secure wireless network, unless explicitly allowed by the network.

A user could also invest in alternative wireless protocols designed for IoT sensors, such as ZigBee® or ZWave®. These solutions require a hub that bridges from the wireless network to the home's IP network, thus incurs the cost of extra hardware. The disclosed solutions, on the other hand, require no extra hardware and leverage the popularity and low-cost hardware of Wi-Fi™. The disclosed design also allows for flexibility. If a user trusts the device or is not worried about being compromised, then the user can still connect the wireless device to the trusted network using normal means. The disclosed software application does not preclude consumers from using the device as a standard Wi-Fi™ sensor.

According to various embodiments, use of LSK is a new communication channel between an untrusted/unassociated wireless device and a device on the trusted wireless network, which can be referred to as the trusted device. The trusted device can be wireless or wired, but for illustrative purposes, can assume is wired. On this new communication channel, the untrusted wireless device can send data to the trusted device on the secure and trusted network. However, direct communication between an unassociated wireless device and the trusted device should not be possible because the communication is encrypted. The insight, therefore, into being able to create this communication channel is that though the unassociated device cannot directly send data to the private network, this untrusted wireless device can still affect the wireless environment. A wired device on the private network cannot directly receive data from the untrusted device, but it can detect changes in the wireless environment.

In various embodiments, this communication can be achieved by having the untrusted wireless device strategically and purposefully jam the communication channel shared with the trusted device, causing the latency of just one device to increase momentarily. Through the pattern in which the unassociated device jams the network conveys information. The trusted device detects, through the communication channel, the changes in network latency and receives the data. This method can be referred to as latency shift keying (LSK), which can be understood as a subprotocol that works independently of other wireless protocols to send data using network latencies. Thus, LSK provides a new communication channel that can be set up between a device in the trusted network and an untrusted/unassociated Wi-Fi™ device. Also, LSK can be viewed as a general-purpose modulation scheme that can be used to transmit arbitrary data.

In addition, the disclosed embodiments employ a software application, which can run on the trusted network device and use LSK to allow a wireless IoT sensor (such as one that joins the trusted Wi-Fi™ network) to send data to a wired (or wireless) entity on the secure network. This software application provides a bridge between the untrusted IoT sensor and the trusted network, and can facilitate obtaining the data which can be used and/or sent elsewhere (such as to a server or cloud computing device). Since LSK offers its own communication channel outside of Wi-Fi™ while still using Wi-Fi™, the software application may create new security associations between unassociated devices and devices on the trusted network. The software application can advantageously be used on commodity hardware. Use of the software application will be demonstrated in a variety of environments, shown to be scalable and robust to other network traffic, and has little impact on network performance. In various embodiments, the current wireless IoT sensors can be employed, allowing data to be sent without completely trusting the sensor, fixing a fundamental problem with the security trust model in present wireless networks such as Wi-Fi™.

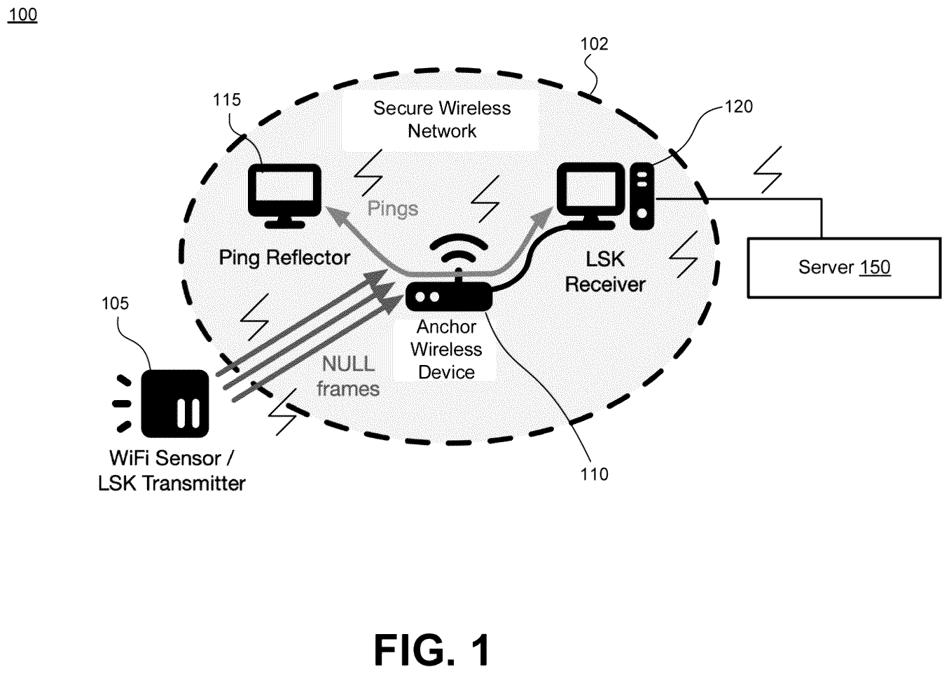

FIG. 1 is a schematic block diagram of an example wireless network 100 functioning with latency shift keying (LSK) according to some embodiments of the present disclosure. Within the wireless network 100 is a secure wireless network 102 (which is trusted by devices associated with the secure wireless network 102), which can be implemented using the Wi-Fi™ wireless protocol (e.g., IEEE 802.11). While Wi-Fi™ is often referred to herein as being the most commonly deployed wireless protocol, other secure wireless protocols are envisioned such as Bluetooth®, Bluetooth® low energy (BLE), LTE or 5G cellular, and long range protocols such as LoRa or LoRa wireless access network (LoRaWAN), all of which include ways to insert latency or spoof latency within the wireless network 100. In at least some embodiments, the disclosed wireless network 100 can be enhanced with LSK to transfer IoT sensor data securely, without having to associate the IoT sensors (or untrusted wireless devices) with the wireless network 100.

For example, in some embodiments, the wireless network 100 includes the secure wireless network 102 and a wireless transmitter device 105, such as an untrusted IoT device, that wants to share data with one or more devices of the secure wireless network 102. Such IoT devices can be sensors and other low-energy and/or low-processing devices that can benefit from sharing data with or receiving data from other devices on the wireless network. In at least some embodiments, the wireless transmitter device 105 is a Wi-Fi-capable wireless device, although other protocols are envisioned, which was just discussed.

The secure wireless network 102 also includes an anchor wireless device 110, a ping reflector device 115, and a receiver device 120 that communicate with the wireless transmitter device 105 through the anchor wireless device 110. The anchor wireless device 110 can be understood to be a wireless router or access point (AP) in most wireless networks, but could also be a wireless base station, a mesh network gateway, a wireless gateway, a cellular base station, a real-time location systems (RTLS) beacon, or an ultra-wide (UWB) positioning system anchor node. While at least a portion of this disclosure assumes that the receiver device 120 is wired into the anchor wireless device 110 (e.g., connect via a wired connection), the receiver device 120 can also connect to the anchor wireless device via a wireless connection.

In at least some embodiments, the wireless transmitter device 105 multiplies data bits with a spreading code to generate spread data, prepends (or attaches) a synchronization word to the spread data, and transmit a pair of null frames via the anchor wireless device 110 to jam the ping reflector device 115 for each chip of a one value within the synchronization word and the spread data, e.g., the latter of which being expressed in chips after being converted via spread spectrum code of the spreading code. While a pair of null frames is referenced, multiple sets of null frames may be transmitted to ensure each chip is successfully transmitted.

In such embodiments, the receiver device 120 (e.g., an LSK receiver) can transmit, via the anchor wireless device 110, multiple ping packets to the ping reflector device at a particular ping rate. The receiver device 120 can further receive ping acknowledgement packets from the ping reflector device 115 in response to the transmitted ping packets. In embodiments, each pair of null frames causes a spike in the ping acknowledgment packets that are received. These spikes can indicates receipt of a chip of the one value, and so intervening reception of non-spikes can be recorded as a zero value. In response to correlating the synchronization word within ones of the ping acknowledgment packets, the receiver device 120 can begin use of the spreading code to decode the spread data encoded within subsequently received ones of the ping acknowledgement packets. This general process for transmitting and receiving IoT data will be described in more detail hereinafter.

The motivation for LSK-based data transmission and reception may include a desire to connect to an IoT device (such as the wireless transmitter device 105) in a home network (such as the secure wireless network 102) without the risk of the IoT device getting compromised and in turn compromising the secure wireless network 102. This is at odds with security association of Wi-Fi™ that gives a device complete access to the secure wireless network 102 once connected. The present embodiments can be directed toward devices that send small amounts of data, such as an environmental sensor, e.g., to be used in applications where receiving data from an unassociated IoT sensor is worth the increased cost of energy to transmit and load on the network. An example of this use case would be the deployment of wireless sensors into homes for research studies. In this case, the sensor deployment is temporary, and the ability to receive data without permanently adding the device to the network would be beneficial. Furthermore, the sensor may be powered externally via wall power, making the additional energy cost to send the data acceptable.

One insight into LSK is that though an untrusted or unassociated device cannot directly send data to a trusted wireless network 102 because of the security model (e.g., of Wi-Fi™), the wireless transmitter device can still impact the wireless environment of that trusted network. This is because Wi-Fi™ is broadcast in nature and though a wireless network might have separated networks, devices still share the underlying radio frequency medium. By having the untrusted device change the environment in a predictable way to send data, a participating device on the trusted network can monitor the environment and decode the data, even from a wired connection.

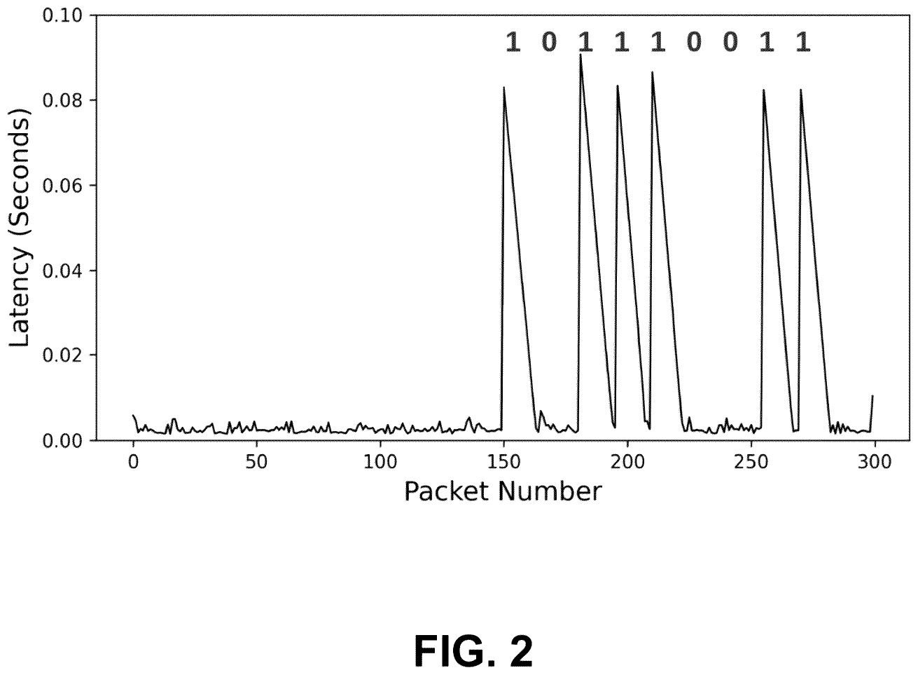

In the case of LSK, latency can be employed as the way to measure the impact on the network. An example of the disclosed approach is shown in FIG. 2. Spikes in latency, caused by the transmitter, convey a one and normal latency conveys a zero, as shown in numbers above the spikes. This method side-steps conventional wireless security, creating a new side channel of communication outside of the scope of Wi-Fi™ security while still using standard Wi-Fi™ hardware. This new communication channel can be employed to create a new (e.g., LSK) network for untrusted IoT devices where the IoT device can send data to the secure wireless network 102 without giving the IoT device access to the secure wireless network 102.

With additional reference to FIG. 1, in some embodiments, the receiver device 120 deterministically induces latency on one device on the wireless network 100 to encode its data. The receiver device 120 can be a wired device on the secure wireless network 102. The receiver device 120 can monitor the latency of the network, looking for encoded messages in the latency. As stated earlier, the receiver device 120 can be wireless, but to demonstrate the versatility of LSK, it can be assumed the receiver device 120 is wired. This demonstrates LSK's ability to work between two different domains, Ethernet and Wi-Fi™.

Additionally, the ping reflector device 115 can be a device that is used by the receiver device 120 to measure the latency of the wireless network 100. The ping reflector device 115 can be a wireless and respond to ping packets. Otherwise, the ping reflector device is oblivious to the LSK protocol. LSK can be implemented purely in software, so does not require modifications to hardware or firmware of the wireless devices of the wireless network 100.

At a high level, the wireless transmitter device 105 needs to cause an increase in latency on the network in a specific timed pattern that the receiver device 120 can measure. To achieve this, the wireless network 100 takes advantage of the insight that an untrusted device can cause latency on a trusted network, even while not being part of the network. There are many ways for an untrusted device to add latency to a wireless network such as a Wi-Fi™ network. The simple act of transmitting on the same channel as the wireless network 100 can cause a slight delay on the wireless network 100. However, for this approach to work well, the delay should be more pronounced and consistent. Three methods are considered for increasing the latency of a network: 1) naive jamming; 2) using 802.11 clear-to-send (CTS) frames; and 3) using 802.11 null frames.

Naive jamming relies on carrier sensing multiple access (CSMA) of the Wi-Fi™ protocol to induce latency on the wireless network 100. By having a jamming device transmit a frame, the target network waits for the transmission to be over plus a random back-off. If the jamming device sends enough frames, competing for airtime with the nodes on the wireless network, the jamming device will have a measurable impact on the network's latency. While this approach is the simplest, this approach has two major drawbacks. First, the approach requires a constant stream of transmissions by the transmitter to make a noticeable impact on the network. This increases the burden on the transmitter. Second, naive jamming slows down the whole network. Slowing down the whole network is a big price to pay for allowing one device to transmit data. While it is feasible to implement LSK using this approach, it is not very practical.

As the second approach to jamming, request-to-send (RTS) and clear-to-send (CTS) frames are used by a Wi-Fi™ station and an access point (AP), such as the anchor wireless device 110, to get exclusive access to the channel to transmit. The typical procedure goes as follows. The Wi-Fi™ station that wants to transmit sends an RTS frame to an AP (e.g., or more generally, the anchor wireless device 110). To grant exclusive access, the AP transmits a CTS in response. All nodes on the same channel as the network that receive this transaction must not transmit on the channel for the duration specified in the RTS/CTS frame. For our context, the LSK transmitter can inject an RTS frame into the network even when it is not associated with the network, asking the AP for access. The AP will broadcast a CTS to all nodes within range of the AP. We considered having the transmitter inject its own CTS into the network, but by using an RTS and involving the AP, we are able to increase the range of the CTS transmission. This method has been used by others to clear the channel. This method compared to the naive approach, reduces the burden on the transmitter requiring only one transmission to clear the channel for a certain amount of time. The duration field of the CTS is limited to 32.767 ms, for example, so the effect a CTS frame can have is limited.

As second approach to jamming, null frames (also called null data frames) are a special type of data frame described in the IEEE 802.11 standard with an empty payload. One of their commonly used purposes is to notify an AP that a Wi-Fi™ station is going into power saving mode. The AP will buffer the frames that it receives on behalf of the device until the device wakes up and sends another null frame to indicate to the AP that the device has woken up. As part of this process, the AP advertises what stations it has buffered frames for in its beacon frame. Since the null frame contains no payload and IEEE 802.11 headers are not encrypted, it is easy for another device to spoof a null frame.

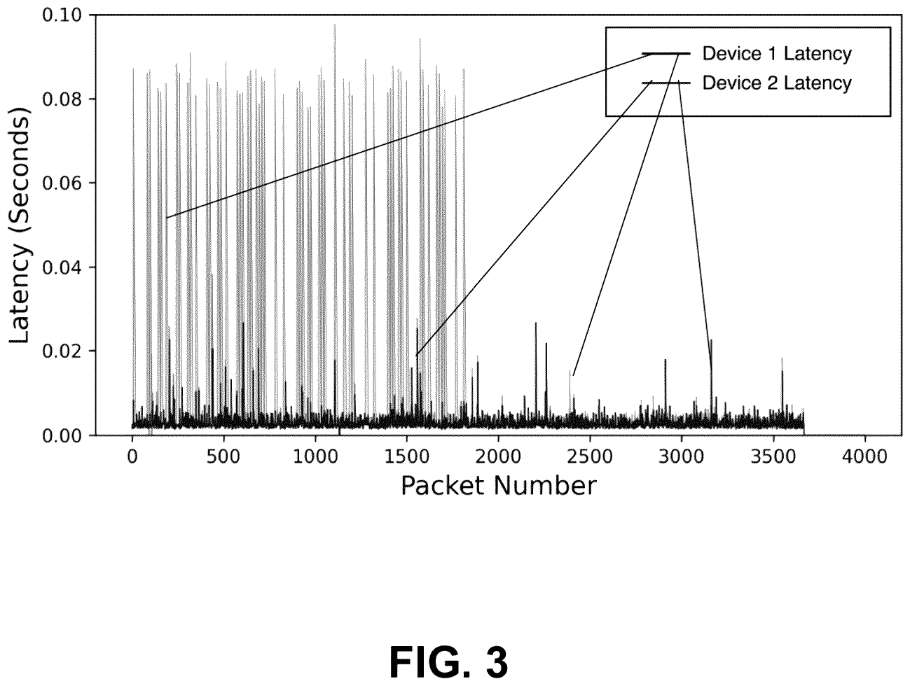

Using null frames, the wireless transmitter device 105 can inject a spoofed null frame targeting a legitimate device on the network. The AP will start buffering the frames for that device. The key insight into using a null frame, as opposed to a different technique, is that a null frame only affects the latency of one device. To show this is the case, we perform an experiment where we ping two devices while sending null frames targeting one of the devices. The results are shown in FIG. 3, which is a graph illustrating round trip time (RTT) between wireless devices (e.g., node 1 and node 2) with null frames directed only at jamming node 1 according to some embodiments.

With reference to FIG. 3, node 1 (or device 1) is the lighter line and node 2 (or device 2) is the darker line. We send null frames targeting node 1 while pinging both nodes 1 and 2. The latency of node 1 is severely affected by the null frames, showing high spikes in latency as a result of the null frames, whereas the latency of node 2 is unchanged. Around packet number 1750, we stop sending null frames to node 1, at which time, the latency follows the same pattern as node 2.

Using null frames minimizes the impact LSK has on other traffic on the network because null frames only affects the one device the transmitter is spoofing null frames for, in this case, the ping reflector device 115. Thus, one wireless device can be jammed independently of any other device on the network. Using this ability, multiple orthogonal communication channels can be created by jamming different devices on the wireless network 100. For example, multiple wireless transmitter devices 105 (e.g., IoT devices) can target different ping reflector devices 115 and create multiple parallel LSK streams of data.

In some embodiments, the wireless transmitter device 105 encodes data in the network's latency by strategically injecting null frames that target the ping reflector device 115. However, even with using null frames and all of the benefits these null frame provide, they are not sufficient to reliably encoding data in the latency of the network. The wireless network 100 should overcome the problem of premature “unjamming” of the ping reflector.

As part of the IEEE 802.11 specification, APs send out beacon frames every 102.4 milliseconds (ms). As mentioned previously, one of the fields of the beacon frame is a list of all of the stations the AP has buffered frames for. While the wireless transmitter device 105 is encoding its data in the latency by injecting null frames, the ping reflector device 115 might receive a beacon frame, because the ping reflector device 115 is not actually in power-saving mode. The ping reflector device 115 can see that the AP has buffered frames for it, and request the buffered packets from the AP, undoing the jam caused by the wireless transmitter device 105 prematurely. This leads to unpredictable spikes in latency since sometimes the jamming will terminate early.

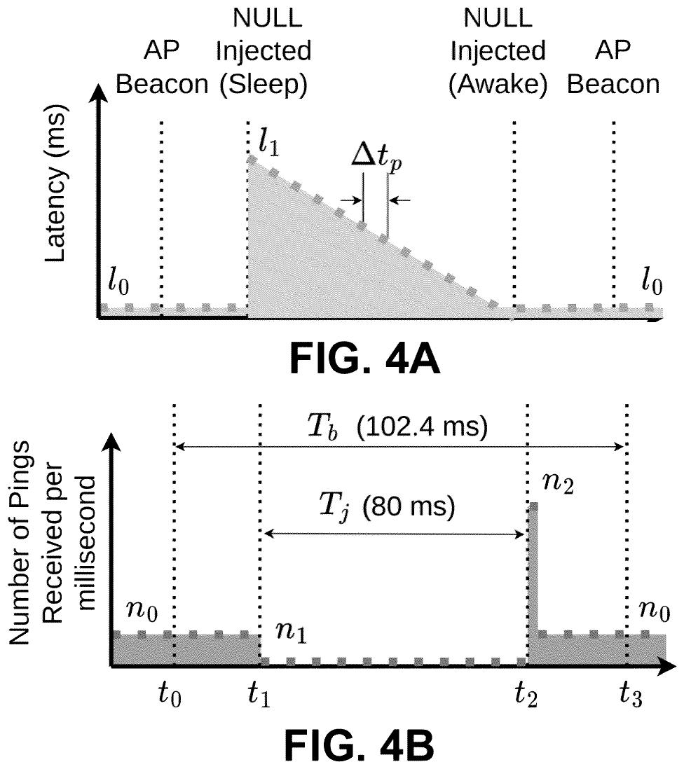

To address this challenge, the disclosed embodiments employ beacon frames as a synchronization mechanism. Before sending null frames, the wireless transmitter device 105 enters monitor mode, which lets the wireless transmitter device 105 sniff for the wireless frames of the secure network. As soon as the wireless transmitter device 105 detects a beacon frame, the wireless transmitter device 105 sends out a null frame, maximizing its ability to jam the ping reflector device 115 via the AP. Before the end of the beacon interval, the wireless transmitter device 105 sends a null frame to the AP requesting packets to be sent to the ping reflector device 115. Using the beacon frame to synchronize prevents potential issues with clock drift between the transmitter and the receiver devices. The time between beacon frames can be used as the basic building block to encode data into the latency. As shown in FIGS. 4A-4B, one peak between two beacon frames can be used to encode chips of spread spectrum data.

With additional reference to FIG. 1, to receive the data (e.g., chips) sent by the transmitter, the receiver device 120 should be able to measure the impact of the transmitter on the wireless environment. To do so, the receiver device 120 picks a wireless node on the network to be the ping reflector device 115 against which to measure latency. In embodiments, the ping reflector device 115 is wireless so that the latency of the ping packets reflects the changes caused by the wireless transmitter device 120. The receiver device 120 can periodically send ping packets to the ping reflector device 115, tracking the latency of the wireless network 100.

In embodiments, the receiver device 120 has different characteristics compared to typical RF receivers that provide a unique challenge in the context of monitoring latency. In the case of the receiver device 120, the signal-to-noise ratio (SNR) is different from a traditional RF receiver. In the wireless network 100, the noise is the natural latency within the wireless network 100. The higher the natural latency of the network, the higher the noise of our system. The signal is the ability of the wireless network 100 to create a spike of latency above the natural latency (i.e., noise floor). The ratio of the latency spike to the natural latency of the network is the SNR.

In various embodiments, two options for measuring the latency of the network can be considered. The first is using the ping utility. This method sends an internet control message protocol (ICMP) echo request to the ping reflector device 115 and the ping reflector device 115 responds back with an ICMP echo response. The receiver device 120 measures the round trip time (RTT) to measure the latency of the wireless network 100. Because of the popularity of the ping utility and its potential for use in attacks, some devices have blocked ICMP traffic or network administrators might rate limit these packets.

In this the wireless network 100 experiences blockage of ICMP traffic, an alternative approach is to use transport control protocol synchronize (TCP SYN) packets instead. This method is the default scanning approach to the Nmap tool. In embodiments, the ping reflector device 115 can either respond with a SYN acknowledgment (ACK) if the destination port is open or reset (RST) if the destination port is closed. The receiver device 120 can measure the time from when the TCP SYN packet is sent to when receiver device 120 receives a response, e.g., the SYN ACK or the TCP reset.

Unlike traditional receiver systems, sampling the channel is not a benign operation, which makes the disclosed approach challenging. A typical receiver's sample rate is limited by its hardware capabilities. However, in the wireless network 100, the sampling rate is limited to the network capacity, and sampling the channel too often can cause adverse effects on the network. Since each “sample” causes two packets to be sent on the network (ping request and ping response), sampling too often will cause congestion, thus increasing the latency of the network. If the receiver device 120 samples too aggressively, receiver device 120 will jam itself. The limiting factor for the wireless network 100 is not how fast the network can be sampled (sending ping packets), but how often the network can be sampled without causing a negative effect on the network.

Traditional RF receiver systems typically have a constant sample rate, however, the wireless network 100 does not have that benefit. If a wireless device sends a ping packet and wait for its response (i.e., sample the channel), then the sample rate will change depending on the latency of the wireless network 100. When the latency is low, the sample rate will be faster and when the latency is high, the sample rate will be slower. To alleviate this problem, the receiver device 120 can send and receive ping packets in parallel. By not blocking each ping packet on the reception of the previous one, we can send ping packets at a constant rate. Each received ping response is aligned with its corresponding sent ping packet to provide a high-fidelity representation of latency over time. To do this, we overload the use of the TCP sequence number as a way of providing a unique identifier (ID). The insight for this to work is that the responding TCP device responds back with an ACK number that is one more than the sequence number, allowing us to overload its meaning and keep its value between the request and response without adding any logic to the ping reflector device 115. When a TCP SYN packet is sent, a random sequence number is inserted into the packet. The response TCP SYN/ACK or RST packet contains an ACK number with the random number, incremented by one. The receiver device 120 matches the response with the corresponding request ID and measures the round trip time. By doing so, the receiver device 120 can have a more consistent sample rate.

In some embodiments, the purpose of the ping reflector device 115 is to have a wireless device that allows the receiver device 120 to measure the latency of the wireless network 100. The ping reflector device 115 can be any wireless device that is already part of the wireless network 100. The ping reflector device 115 is unaware of LSK and its purpose is therefore to respond to ping packets. As discussed in more detail later, the jamming on the ping reflector device 115 has very little impact on its overall throughput.

FIG. 4A is a graph illustrating the impact of network latency from injecting a pair of null frames into the wireless network from a latency domain perspective in accordance with some embodiments. FIG. 4B is a graph illustrating the impact of the injecting the pair of null frames (as in FIG. 4A) from a number of pings received per millisecond perspective, according to some embodiments. In various embodiments, encoding data in the latency of a network presents exciting challenges due to the interdependence between the various modulation parameters. FIG. 4A shows the jam from the latency domain while FIG. 4B shows the same jam from the number of received packets domain. The latency increases from the baseline l₀ to l₁ at time t₁, which corresponds to the first null frame. Latency decreases back to the baseline over the duration of the jamming interval Tⱼ (FIG. 4A). This triangle shape makes it harder to detect using conventional signal processing techniques. To solve this problem, the receiver device 120 can instead interpret the number of pings received per millisecond (FIG. 4B). This creates a sharp spike after the jamming occurs. When the network is un-jammed at t₂, all buffered ping packets are received in less than 1 millisecond, and the receiver device 120 can observe the spike in received traffic due to the jamming as a single data point n₂, occurring at time t₂. This method provides a more time-deterministic representation of the modulated latency, and is used by the a decoder in the receiver device 120.

We observe that the SNR of in the wireless network 100 in ideal conditions would be represented as the ratio of n₂/n₀. Since n₂ represents the number of buffered packets over Tⱼ, all received within 1 ms, we can maximize the SNR by increasing Tⱼ. However, as discussed, if Tⱼ exceeds the beacon interval, the ping reflector device 115 can automatically become un-jammed at t₃. We maximize the SNR in a single beacon interval by selecting Tⱼ to be as large as possible without interfering with the next beacon.

If one bit were sent per beacon interval, and every attempt to jam the channel is successful, then we would achieve a data rate of

$$\frac{1 bit}{102.4 ms} = 9.76 bps .$$

However, there are network phenomena that interfere with this encoding scheme and cause an unpredictable degradation of SNR. Data can be buffered naturally by either the router, ping reflector, or the networking stack on the receiver, resulting in latency spikes not triggered by an LSK transmitter. The null frames are injected into the wireless network 100 without any guarantee of being received by the anchor wireless device 110, and are occasionally missed, resulting in a missing latency spike for a given beacon interval.

To increase the overall SNR of our system, reduce bit error, and deal with naturally occurring latency spikes in the network, the wireless transmitter device 105 encodes data using a pseudo-noise (PN) code similar to direct sequence spread spectrum. The transmitter and receiver share the code that is used to encode/decode the data. This provides coding gain to the wireless network 100, allowing the receiver device 120 to decode data in spite of a capped SNR and external network interference. In this context, the transmitter device 120 encodes the data by multiplying a stream of data with the PN code. To send a binary one, the transmitter device 105 sends the PN code and to transmit a binary zero, the transmitter device 105 sends the inverse of the PN code. The PN code consists of chips, with a one chip being the presence of high latency and a zero chip being a normal value of latency.

In some embodiments, two different PN codes can be employed, one for synchronizing the transmission with the receiver device 120 and one for spreading the data. We select a particular maximal length sequence (MLS) code to use as the synchronization word (or synch word) in order to give a strong autocorrelation while searching for the packet. In one embodiment, the MLS code is 31 bits long. To encode each of the data bits to be transmitted, 11-bit Barker Codes are used to provide a balance between an adequate autocorrelation and preserving data rate.

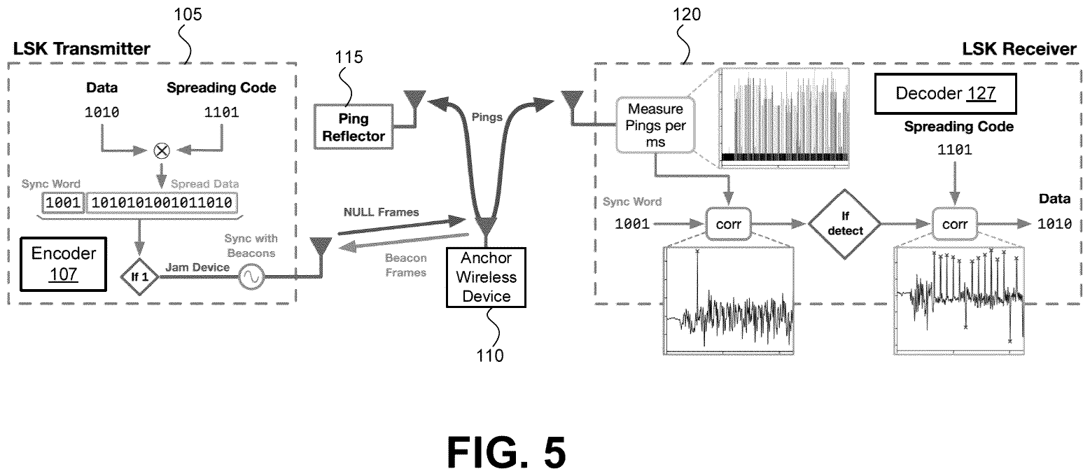

FIG. 5 is a schematic block diagram illustrating the interactions, through the anchor wireless device 110, between the wireless transmitter device 105 and a receiver device 120 operating a local LSK network to securely send IoT-related data according to some embodiments. The data, spreading code, and synchronization word are merely small examples to illustrate the flow of data and are not the actual values used in our experimental network.

In some embodiments, the transmitter device 105 includes an encoder 107 configured to encode data (e.g., using spread spectrum), which can then be transmitted within latency spoofed within the wireless network 100 such as through jamming the ping reflector device 115. In embodiments, the encoder 107 takes arbitrary data and multiplies the data by the PN code, generating spread data. The encoder 107 can prepend a synchronization word to spread data, e.g., and be located at the front of the packet, also in spread spectrum chips.

Once the synchronization word and the spread data is encoded in spread spectrum chips, the transmitter device 105 can cause each of the encoded chips to be transmitted via the network latency. For example, if the chip is a one, the wireless transmitter device 105 jams the wireless network 100. If the chip is a zero, the wireless transmitter device 105 does nothing and waits for a chip interval for the next chip.

In disclosed embodiments, to jam the wireless network 100, the wireless transmitter device 105 waits for a beacon to be transmitted and then sends a null frame to jam the ping reflector device 115. During this time, the receiver device 120 is pinging the ping reflector device 115, measuring the ping packets per millisecond. The receiver device 120 correlates the samples with the synchronization word. When the synchronization word is detected, the receiver device 120 switches to employing a decoder 127 to use the spreading code to decode the data. Using this method, the wireless transmitter device 120 is able to encode data into the latency of the wireless network 100 and the receiver device 120 is able to decode the data.

By transmitting a single chip per beacon interval, and using an 11-bit Barker code that generates 11 chips per bit of data to transmit, the wireless transmitter device 105 is able to transmit a single bit per 11 beacon intervals. This results in an overall system data rate of

$$\frac{1 bit}{0 \text{.1024} \cdot 11} = 0.89 bps .$$

This rate is slow compared to typical Wi-Fi™ data rates, however, for the context of IoT sensors, this data rate works great. For example, an IoT sensor that reports data every five minutes would have more than enough bandwidth to send its data. For these types of devices and use cases, having a slow data rate is not a problem.

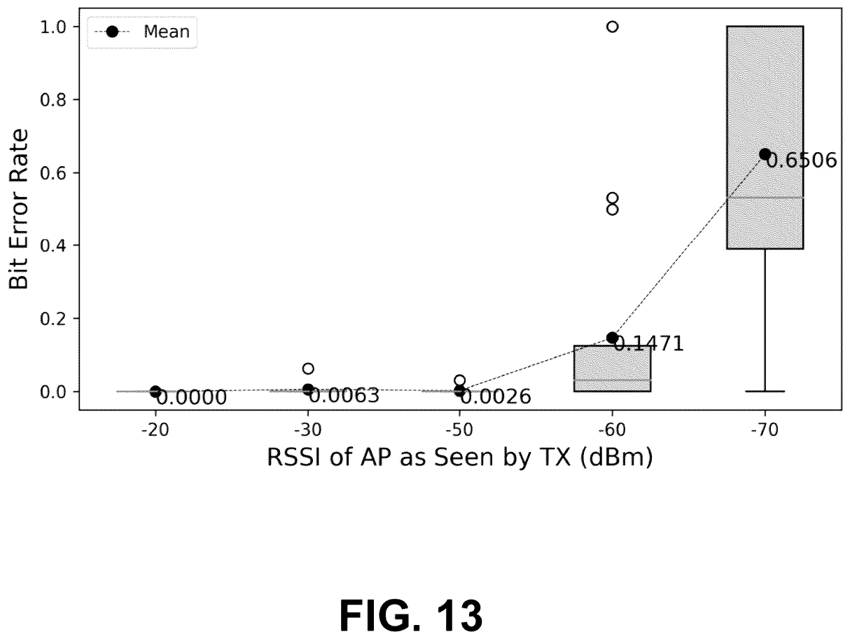

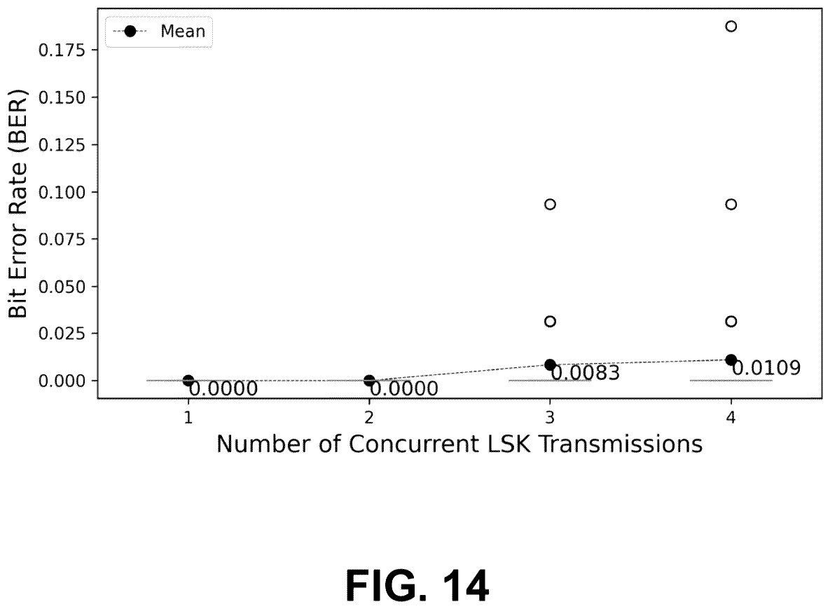

In various embodiments, the wireless network 100 can be partitioned using LSK. For example, LSK is a general-purpose modulation scheme that encodes data in the latency of the wireless network 100. In some embodiments, the disclosed software application layer protocol uses LSK to partition the network for IoT devices. Since Wi-Fi™ does not easily provide fine-grained access control to devices, the software application fills in the gap, allowing an untrusted wireless device to send data to a willing receiver device on the trusted or secure wireless network 102. In some embodiments, this software application is executed on the receiver device 120, which can be implemented as a combination of the wireless device 1300 (FIG. 13) and the computing device 1400 (FIG. 14).

In some embodiments, the software application is initiated on the receiver device 120, signaling to start receiving data from the wireless transmitter device 105. The receiver device 120 first selects a suitable ping reflector device 115. A good ping reflector is a device that is wireless but has low variation in latency, for example. The IP address of the ping reflector device 115 can be provided by the user of the application, determined through some other means (such as what is done with Amazon's “Wifi Simple Setup”), or discovered automatically by the receiver device 120. Once the receiver device 120 has selected a ping reflector device 115, the receiver device 120 starts sending ping messages, as discussed previously, to sample the network's latency. The software application is also set up to forward the data it receives to another node or to display it.

In some embodiments, the purpose of software application is to side step a potential security threat of providing a network's credentials to an untrusted device, thus giving the IoT (the wireless transmitter device 105) full access to the network. One threat scenario includes an adversarial device connecting to a network using the software application. Another threat scenario is where an adversary attacks the communication between an LSK transmitter and receiver. By serving as a low-bandwidth channel between a sensor and the software application on the network that is expecting only a certain data type, the ability of the new wireless device to compromise the wireless network security is significantly limited. The new wireless device is partitioned from the rest of the network by the software application that is receiving the data, so new wireless device cannot contact other devices directly. The software application is designed to only receive data from the sensor and upload the data to a server 150. This puts a user in control of where the software application sends the data. An attacker would need to compromise the software application, changing its behavior, in order to compromise the wireless network 100, which is much more challenging compared to compromising a typical Wi-Fi™ network.

In terms of an adversary attacking the communication between an LSK transmitter and receiver, the main areas of concern for the security of our protocol would be maintaining the confidentiality, integrity, and availability of the sensor data itself. If needed, the data from the sensor could be encrypted and integrity protected to guarantee confidentiality and data integrity. An attacker could compromise the availability of the LSK data by causing network interference, but the same threat vector applies to normal Wi-Fi™ communication. LSK provides no additional security vulnerabilities compared to typical wireless communication and standard security practices can be used to protect the data.

The transmitter device 105 has a bootstrapping problem in not knowing the medium access control (MAC) address of the ping reflector in order to try to jam it. To solve this problem, when the receiver device 120 sends a ping, the receiver device 120 can insert a unique identifying source MAC address into the Ethernet frame, instead of its own MAC address (which will be discussed in more detail later). The transmitter device 105 can go into monitor mode which lets the transmitter device 105 receive raw 802.11 frames, looking for the identifying source MAC addresses (which uniquely identify LSK packets).

Two key insights make this possible. First, Wi-Fi™ is inherently broadcast in nature, so even if a ping packet is unicast, the ping packet will be broadcast wirelessly for any device listening to receive. Second, though the transmitter device 105, which is untrusted and not part of the secure network, cannot decode the payload of packets since they are encrypted, the transmitter device 105 can see the source and destination MAC addresses of packets, which are not encrypted. For example, Wi-Fi™ does not encrypt the link layer header information.

Thus, in disclosed embodiments, detecting one of these frames (e.g., in a ping acknowledgement packet) indicates to the transmitter device 105 that there is an LSK receiver present on the channel. The frames also give the transmitter device 105 all of the information to know the anchor MAC address of the anchor wireless device 110 and the ping MAC address of the ping reflector device 115. In spite of the receiver device 120 using an incorrect source MAC address, the ping packets still get returned to the receiver, as ping acknowledgement packets, because the correct IP address is used for Ethernet delivery.

Thus, in at least some embodiments, to bootstrap communicating data between the transmitter wireless device 105 and the receiver device 120, the receiver device 120 can transmit a ping packet with a set of internet protocol (IP) addresses, a ping medium access control (MAC) address of the ping reflector device 120, and an identifying MAC address that uniquely identifies the receiver device 120 and a LSK network in which the transmitter device 105 operates. In such embodiments, the anchor wireless device can insert, to the ping packet, an anchor MAC address of the anchor wireless device and transmit the ping packet to the ping reflector device 115. The anchor wireless device 110 can also transmit a ping acknowledgment, responsive to the ping packet, to the receiver device 120. In such embodiments, the transmitter wireless device 120 detects that the ping acknowledgement packet includes the identifying MAC address. The receiver device 120 can extract, from the ping acknowledgement packet, a ping MAC address of the ping reflector device 115 and the anchor MAC address (of the anchor wireless device 110) for use in jamming the ping reflector device 115.

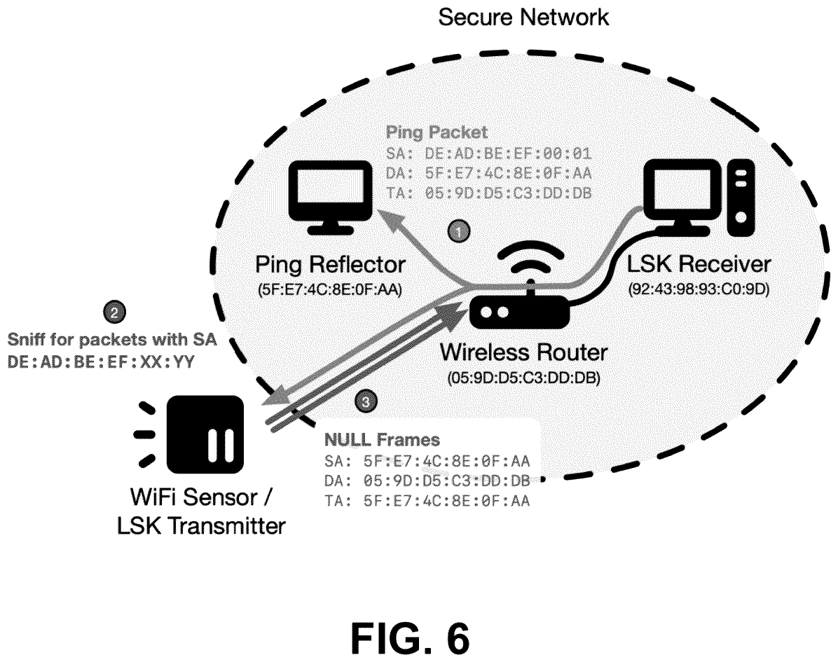

FIG. 6 is a schematic block diagram similar to that of FIG. 1, illustrating a bootstrapping procedure through which the wireless transmitter device 105 identifies the anchor wireless device 110 and the receiver device 120 with which to communicate over the local LSK network according to some embodiments. In embodiments, the receiver device 120 sends a ping packet with the device's IP addresses and device's destination MAC address, but also with the identifying source MAC address. The anchor wireless device 110 can insert its own, e.g., anchor MAC address into the transmitter address of the 802.11 frame and send the ping packet wirelessly to the ping reflector device 115. The ping reflector device 115 can respond to the ping request and sends its response, e.g., a ping acknowledgement packet to the receiver device 120. During the same time, the transmitter device 105 enters a monitor mode, sniffing for frames (e.g., within ping acknowledgement packet) with the identifying source MAC address. Once the wireless transmitter device 105 detects such a frame, wireless transmitter device 105 knows the ping MAC address (the source address of the frame) and the anchor MAC address of the anchor wireless device 110 (the transmitter address of the 802.11 frame). This is all of the information the transmitter device 105 needs to know to start encoding data into the latency of the network.

As mentioned previously, sending null frames to different devices acts as an orthogonal channel. This ability can be employed to provide multiple access control in two ways, channel partitioning (using multiple ping targets) and time division (using the same ping target). If multiple sensors want to send data at the same time, these IoT sensors can target different ping reflector devices with the receiver device 120 pinging two devices in parallel. To provide channel partitioning and time division capabilities, a packet structure is designed for conveying important information to the wireless transmitter device 105.

In various embodiments, an LSK code word such as DE:AD:BE:EF:XX:YY can be used as the packet structure. For example, DE:AD:BE:EF can be an identifier for the receiver device 120 (on which the LSK protocol-based software application is executed), XX can represent a unique identifier for the LSK network itself (and thus can represent one or more IoT devices that are allowed to participate in that LSK network), and YY can represent whether or not the channel is already being used, e.g., whether it is busy. Together with the source address to identify the ping reflector device 115 and the transmitter address to identify the anchor wireless device 110, the transmitter device 105 is able to gain detailed information about the state of LSK on the wireless network 100. Further, XX can be used to uniquely identify a specific deployment or location of the LSK network so that if multiple LSK networks are deployed nearby, participating wireless devices can differentiate themselves. This packet structure can be programmed by a user through the software application running on the receiver device 120.

In some embodiments, the receiver device 120 changes YY from 00 to 01 when a synchronization word is detected and the channel becomes busy. The transmitter device 105 can look for a source MAC address with that form (DE:AD:BE:EF:XX:YY) and can identify how many channels are available and which channels are currently being used. If all the channels are full, multiple transmitter devices can be multiplexed in time using the YY field as a way to know if the channel is busy. For example, once a channel moves from busy to empty, the transmitter device 105 can wait a random back-off time period and if the channel is still not being used, can start sending its data.

Depending on the needs of the transmitter devices, a single ping reflector device can handle multiple devices. If the channel is too busy, additional ping reflector devices can be added to provide additional channels. Using the destination MAC address as a way to pass information to the transmitter provides much flexibility for the software application to adapt to the needs of the wireless transmitter devices 105 (e.g., IoT devices) and the wireless network 100.

In various implementations, the Espressif ESP32 development board was selected as the wireless transmitter device 105 because it is a popular Wi-Fi™ system-on-a-chip (SoC) for IoT devices, provides a bare metal system to get more accurate timing characteristics, and provides a direct application programming interface (API) for the Wi-Fi™ module. Since the transmitter device 105 sends the null frames timed relative to the beacon frames, with response times less than 10 ms, a real-time system can be used. In a traditional operating system, the delay from when a beacon frame is received by the Wi-Fi™ chipset and is processed by the software application is non-deterministic and often larger than the 10 ms window that is wanted. By utilizing the ESP32, the transmitter application can run bare metal and provide the precise timing required to induce buffering on the wireless network 100 in a consistent manner. The data to be transmitted is first spread into an array containing the 1's and 0's for each chip in the 31-bit MLS synchronization word, followed by chips of 11-bit Barker codes for each of the application data bits to be transmitted.

Prior to transmission, the ESP32 can sniff visible packets in the air, searching for the LSK code word in the source MAC address, as described previously. When the LSK code word is detected in a packet, the transmitter device 105 can assume the packet is a valid TCP packet being sent to the ping reflector device 115 to be spoofed. The transmitter device 105 can then use the destination MAC address from that packet as the source address in a new null frame packet. The destination MAC address for this new packet is the MAC address of the anchor wireless device 110, which is also obtained from the sniffed packet.

The wireless transmitter device 105 can then begin a state machine that is triggered by the reception of each beacon frame. A timer is also used to trigger the state machine in the event that one or more beacons are missed. This results in very precise timing that allows the transmitter device 105 to synchronize the injection of the null frames and have precise control over the introduced latency. The state machine can be initialized with a chip pointer to the first chip in the encoded data to be transmitted. For each iteration, the following actions can be taken: 1) If the current chip to transmit is a ‘1,’ transmit a null frame triggering the anchor wireless device 110 to start buffering frames for the ping reflector. Delay for Tⱼ ms, then send another null frame to release the buffered frames. Increment the chip pointer. 2) If the current chip to be transmitted is a ‘0,’ then do nothing, increment the chip pointer, and wait for the next state machine iteration. The jamming interval Tⱼ is selected to be 80 ms, as that provides an adequate SNR while not risking interference from the next beacon.

In some embodiments, the receiver device 120 is implemented in Python using a Linux-based laptop computer, connected via Ethernet to the anchor wireless device 110. A ping interval Δtₚ of 5 ms between pings is selected for our implementation, which strikes a balance between high-fidelity latency sampling and SNR while not adding too much load to the network. The receiver device 120 can measure the network latency by using the Python multiprocessing and scapy libraries in the following way. First, two processes are started. One of the processes is used to monitor all traffic on the Ethernet interface. The second process sends TCP SYN packets to all the ping reflectors, with a 5 ms delay between packets. As responses come back to the receiver device 120, the first process matches each TCP SYN packet with the corresponding TCP RST packet (or SYN/ACK packet if the port is open) based on the sequence number, calculating the round-trip-time (RTT). This data is then sent to the decoder for processing.

In at least some embodiments, the decoder 127 of the receiver device 120 begins by constructing a new 2-dimensional array with the first dimension made up of 1 ms intervals that span the duration of the capture. Then, for each interval, the number of response TCP packets (e.g., the ping acknowledgement packets) received within the interval is recorded in the second dimension. To make correlation easier, the data set is then further conditioned by taking a rolling variance across the data. Using variance provides a stronger impulse response when the latency increases due to the jamming.

In such embodiment, there are at least two correlation operations that can be performed to decode the LSK message, namely, of the synchronization word and message payload. Both the synchronization word and the message payload codes are individually correlated with the smoothed variance data. After correlation is performed for both codes, a zero mean is calculated for the data of each of the synchronization word and the payload data. The decoder 127 can be considered synchronized once the synchronization word correlation data exceeds a threshold of two times the standard deviation of the data. If synchronization occurs, the data can be demodulated from the Barker code correlation data.

When the payload data is modulated, the payload is synchronized with the beacon frame intervals of the anchor wireless device 110. This cases the demodulation of the data since the transmitter device 104 does not are about the ping interval and transmitter jamming getting out of synchronization. From the point of synchronization of the synchronization word, the Barker code correlation data is sampled every 102 samples since the data is broken into 1 ms windows and beacon frames come every 102.4 ms. At each sample point, the demodulation algorithm can adaptively adjust where samples are taken based on nearby peaks in correlation to adjust for sampling jitter. Data bits can then determined based on whether the correlation value is above or below zero, one being above and zero below.

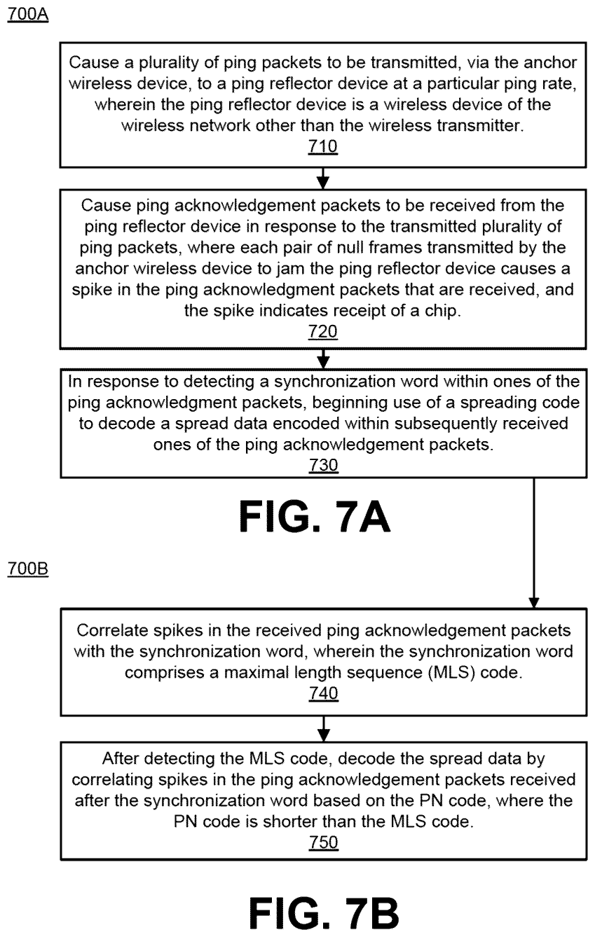

FIG. 7A is a flow chart of a method 700A for leveraging LSK, imposed by injecting null frames, to communicate data from the wireless transmitter device to the receiver device according to some embodiments. The method 700A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700A is performed by the wireless network 100, with a particular focus on the receiver device 120 and the anchor wireless device 110.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 710, the processing logic causes a plurality of ping packets to be transmitted, via the anchor wireless device 110, to a ping reflector device 115 at a particular ping rate. In embodiments, the ping reflector device 115 is a wireless device of the wireless network other than the wireless transmitter 105.

At operation 720, the processing logic causes ping acknowledgement packets to be received from the ping reflector device 115 in response to the transmitted plurality of ping packets. In embodiments, each pair of null frames transmitted by the anchor wireless device 110 to jam the ping reflector device 115 causes a spike in the ping acknowledgment packets that are received, and each spike indicates receipt of a chip.

At operation 730, in response to detecting a synchronization word within ones of the ping acknowledgment packets, the processing logic begins use of a spreading code to decode a spread data encoded within subsequently received ones of the ping acknowledgement packets.

In some embodiments, the plurality of ping packets are transmitted as internet control message protocol (ICMP) requests and the ping acknowledgement packets are received as ICMP responses. The processing logic can further calculate round-trip time (RTT) based on a time elapsed being transmitting the ICMP requests and receiving the ICMP responses.

In other embodiments, the plurality of ping packets that are transmitted as transport control protocol synchronize (TCP SYN) packets. In such embodiments, the ping acknowledgement packets are each a SYN acknowledgement if a destination port is open or a TCP reset packet if the destination port is closed on the ping reflector device.

In at least some embodiments, the processing logic causes the plurality of ping packets to be transmitted in parallel with receiving the SYN acknowledgements. The processing logic can insert a random sequence number in each ping packet as an identifier. The processing logic can detect the random sequence number plus a one value in each SYN acknowledgment in order to match each respective ping to a corresponding SYN acknowledgment.

FIG. 7B is a flow chart of a method 700B of the receiver device correlating ping acknowledgement packet spikes with the synchronization word followed by decoding the spread data using the spreading code according to some embodiments. The method 700B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700B is performed by the wireless network 100, with a particular focus on the receiver device 120 and the anchor wireless device 110.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 740, the processing logic correlates spikes in the received ping acknowledgement packets with the synchronization word. In embodiments, the synchronization word is a maximal length sequence (MLS) code.

At operation 750, after detecting the MLS code, the processing logic decodes the spread data by correlating spikes in the ping acknowledgement packets received after the synchronization word based on the PN code. In embodiments, the PN code is shorter than the MLS code.

In some embodiments, the operations of the method 700B can be further articulated as follows. The processing logic can track a number of ping acknowledgement packets received within each of a plurality of intervals (e.g., of the 1 ms intervals for pinging). The processing logic can determine a rolling variance across the number of ping acknowledgement packets in each interval of the plurality of intervals to generate smoothed variance data associated across the plurality of intervals. The processing logic can correlate the smoothed variance data with the synchronization word within a first set of the ping acknowledgement packets to generate synchronization word correlation data. The processing logic can determine that the synchronization word correlation data exceeds a threshold of two times a standard deviation of the smoothed variance data to confirm synchronization of the synchronization word. In response to determining that the synchronization word has synchronized to the smoothed variance data, the processing logic can further correlate, using the spreading code, the smoothed variance data to message payloads of the subsequently received ping acknowledgement packets to generate spreading code correlation data. The processing logic can also retrieve a sample from a plurality of samples of the spreading code correlation data at a frequency of beacon frames transmitted by the anchor wireless device. For each retrieved sample, the processing logic can also determine a data bit as a one value when a correlation value is above zero and as a zero value when the correlation value is equal to or below zero.

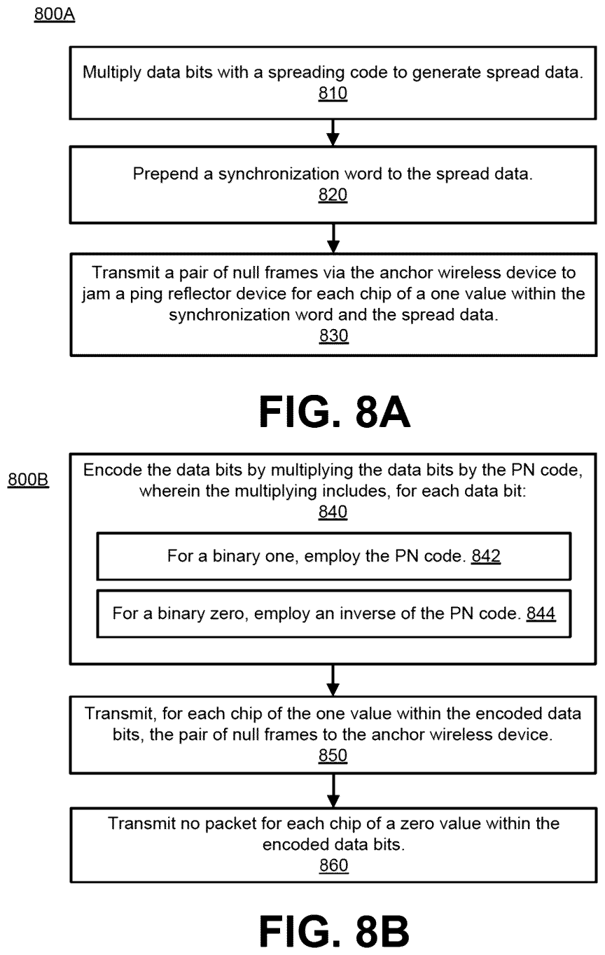

FIG. 8A is a flow chart of a method 800A of the wireless transmitter device encoding spread spectrum chips, which represent data and are transmitted via null frames that generate detectable latency in the wireless network according to some embodiments. The method 800A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 800A is performed by the wireless network 100, with a particular focus on the wireless transmitter device 105 and the anchor wireless device 110.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 810, the processing logic multiplies data bits with a spreading code to generate spread data, e.g., which is expressed in chips. In some embodiments, the spreading code is a pseudo-random (PN) code such as an 11-bit Barker code discussed herein.

At operation 820, the processing logic prepends a synchronization word to the spread data.

At operation 830, the processing logic transmits a pair of null frames via the anchor wireless device 110 to jam a ping reflector device 115 for each chip of a one value within the synchronization word and the spread data. In embodiments, the ping reflector device 115 is a wireless device of the wireless network other than the receiver device.

In some embodiments, the processing logic causes a ping packet, of the plurality of ping packets, to be transmitted that includes an identifying media access control (MAC) address in an Ethernet frame in lieu of a MAC address of the receiver device. In such embodiments, the identifying MAC address includes a first identifier of the receiver device 120, a second identifier of a latency shift keying (LSK) network (e.g., as a sub-network within the wireless network 100), and a field to indicate whether a channel associated with the ping reflector device is busy.

FIG. 8B is a flow chart of a more-detailed method 800B of employing a pseudo-random (PN) code to encode the data into spread spectrum chips and how each chip can be transmitted via use of null frames according to some embodiments. The method 800B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 800B is performed by the wireless network 100, with a particular focus on the wireless transmitter device 105 and the anchor wireless device 110.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 840, the processing logic encodes the data bits by multiplying the data bits by the PN code. In embodiments, this PN code multiplying includes, for each data bit, performing either operation 842 or operation 844. At operation 842, for a binary one, the processing logic employs the PN code in the bit multiplication. At operation 844, for a binary zero, the processing logic employs an inverse of the PN code in the bit multiplication.

At operation 850, the processing logic transmits, for each chip of the one value within the encoded data bits, the pair of null frames to the anchor wireless device.

At operation 860, the processing logic transmits no packet for each chip of a zero value within the encoded data bits.

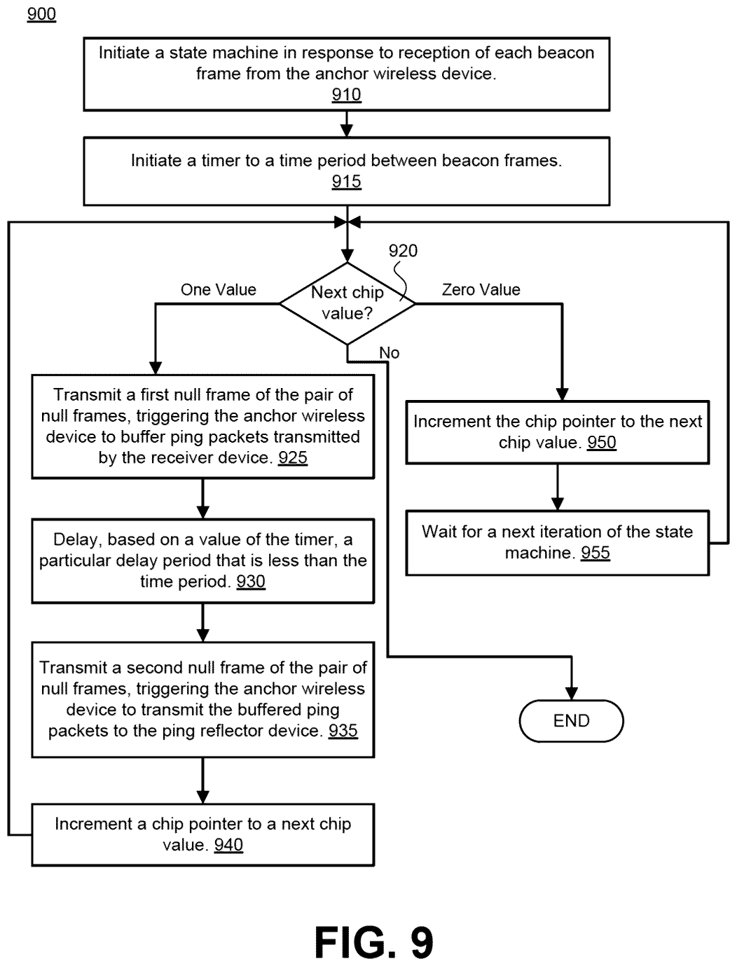

FIG. 9 is a flow chart of a method 900 to be executed by a state machine of the wireless transmitter device 105 to control timing of transmitting each pair of null frames, relative to beacon frames, to encode a chip of the spread data according to some embodiments. The method 900 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 900 is performed by the wireless network 100, with a particular focus on the wireless transmitter device 105 and the anchor wireless device 110.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In embodiments, by way of summary, the state machine can be configured to cause the wireless transmitter device 105 to monitor wireless packets for beacon frames from the anchor wireless device 110. The transmitter device 105 can further waiting to detect a first beacon frame before transmitting a first null frame of the pair of null frames. In embodiments, the first null frame signals to the anchor wireless device 110 to buffer a plurality of ping packets received from the receiver device 120. The transmitter device 105 can further transmit a second null frame of the pair of null frames before receipt of a second beacon frame following the first beacon frame. In embodiments, the second null frame causes the anchor wireless device 110 to transmit the buffered plurality of ping packets, causing a spike in ping acknowledgement packets received by the receiver device.

With additional specificity, broken down in more discrete operations, at operation 910, the processing logic initiates the state machine in response to reception of each beacon frame from the anchor wireless device 110. Such initiation can include pointing chip pointer to a first chip in the spread data to be transmitted.

At operation 915, the processing logic initiates a timer to a time period between beacon frames. In some embodiments, the method 900 can then iterate through the state machine depending on chip values within the synchronization word and the spread data, as follows.

At operation 920, the processing logic determines whether there is another chip to be transmitted. If there is no more chips, the method 900 ends.

Assuming there are chips to be transmitted, for a one chip value, at operation 925, the processing logic transmits a first null frame of the pair of null frames, triggering the anchor wireless device 110 to buffer ping packets transmitted by the receiver device 120.

At operation 930, the processing logic delays, based on a value of the timer, a particular delay period that is less than the time period.

At operation 935, the processing logic transmits a second null frame of the pair of null frames, triggering the anchor wireless device 110 to transmit the buffered ping packets to the ping reflector device 115.

At operation 940, the processing logic increments a chip pointer to a next chip value.

Assuming there are chips to be transmitted, for a zero chip value, at operation 950, the processing logic increments the chip pointer to the next chip value.

At operation 955, the processing logic waits for a next iteration of the state machine. In this way, a zero chip value can still be encoded within the latency of the wireless network 100 by not sending null packets while creating a gap or delay before a next chip that is transmitted.

The following discussion is an evaluation of real-world performance of the LSK-based protocol in several ways to understand its flexibility and reliability. For most evaluation, we evaluate the software application since it tests the whole system which uses LSK. By evaluating the software application, LSK is also evaluated.

To verify the performance of software application and LSK, data is sent from the transmitter device 105 to the receiver device 120, and the received data is compared against the expected data to generate a bit error rate (BER). To demonstrate that the wireless network 100 is not dependent on input data, 10 randomly generated 32-bit sequences are used as payloads to transmit. The size of the data payloads was selected to represent a single packet containing compressed sensor data. A test includes each of the 10 sets of data being sent from the transmitter to the receiver, and the calculated BER for each data set is averaged together to provide a single result for the test.

Evaluation was performed in a home Wi-Fi™ environment with interference levels typical of a residential IoT sensor application. Wi-Fi™ channel 11 is selected for testing. As discussed, the baseline channel utilization rate as reported by the access point was approximately 20%. For the tests used in the evaluation, channel utilization is measured by monitoring the quality of service (QOS) basic service set (QBSS) Load Information Element (IE) of the beacon frame, which reports the channel utilization rate as an 8-bit value. This was averaged together over 1-second intervals, and collected for the duration of each test.

Functionality of the LSK-based operation was assessed in terms of interoperability with various Wi-Fi™ routers, which operated as the anchor wireless device 110 (FIG. 1 and FIG. 5). The software application and LSK were designed to not require any custom firmware or manufacturer-specific features of the Wi-Fi™ router, relying on core features of the IEEE 802.11 protocol. As such, we expect that software application should perform well on a wide variety of Wi-Fi™ routers. To test this, we verify that our protocol can be run using three different routers, as shown in Table 1. We selected these routers because they represent a broad spectrum of router capabilities, brands, and costs. In all cases, the LSK protocol consistently achieves a BER of zero on all three routers under typical conditions. This shows that our protocol utilizes fundamental Wi-Fi™ features and is not dependent on router or protocol behavior.

TABLE 1

| Router Model | Wi-Fi ™ Version | Cost |
|---|---|---|
| Linksys MR7500 | Wi-Fi ™ 6E | $230 |
| Netgear Nighthawk AC2600 | Wi-Fi ™ 5 | $154 |
| TP-Link Archer AC1200 | Wi-Fi ™ 5 | $40 |

In some embodiments, the effects of existing Wi-Fi™ network traffic on software application performance was assessed. As discussed previously, buffering in an LSK network occurs not only as the result of the null frames injected by the transmitter, but by naturally occurring network conditions as well. In wireless environments with low network load, nearly all buffering is caused by the transmitter device 105 (e.g., IoT device). However, when the network is more congested, buffering may occur naturally on either the anchor wireless device 110 or the ping reflector device 115. In both cases, this can interfere with the timing of the LSK-induced buffering and introduce bit errors into our communication. The below discussion evaluates at what point external network congestion will degrade the LSK communication channel.

To measure this, the wireless network 100 is loaded with traffic in a controlled manner using iPerf. While iPerf is typically used to measure the maximum throughput of a network, it also allows an input argument to specify a target throughput to test and will maintain that throughput consistently through the duration of the test. An iPerf server was launched on a test computer connected to the router via Ethernet, and an iPerf client was launched on a device connected to the 2.4 GHz Wi-Fi™ network. This topology allows us to place a controlled load on the 2.4 GHz network simulating external network traffic.

The channel is first characterized by running iPerf at maximum speed, which for this evaluation indicates a maximum channel capacity of 80 Mbps. A series of tests are then performed while the iPerf client streams data at 10 Mbps, 20 Mbps, 30 Mbps, and so forth up to the point where the software application communication is observed to break down. The baseline channel utilization rate with no software application communication and no iPerf load is 20% as reported by the anchor wireless device 110. Because the observed channel utilization is not constant but varies by up to 15% over time, the test results are grouped by the observed utilization rate from when each data set is recorded.

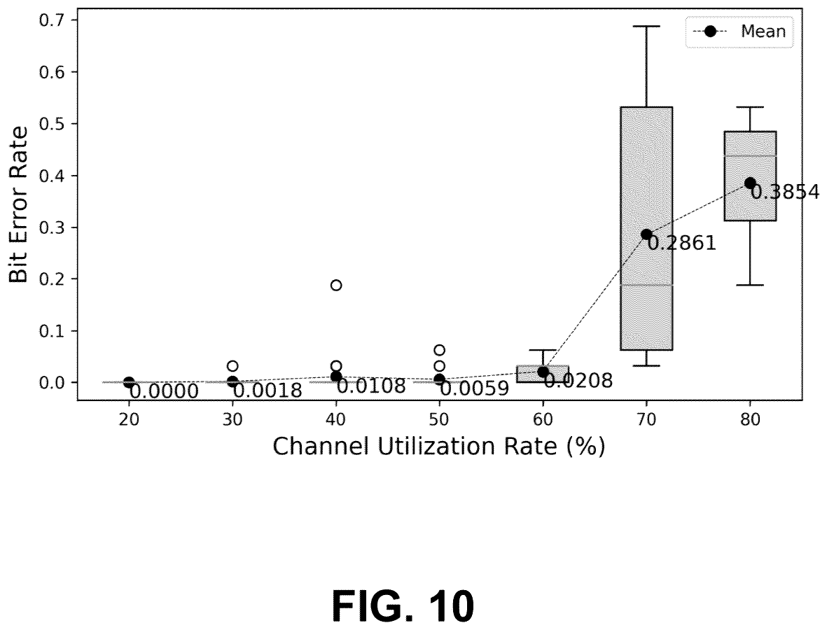

FIG. 10 illustrates the distribution of test results of the software application for each of the observed utilization rates according to some embodiments. It can be seen that for the topology and encoding used, the data was successfully received up to a 60% utilization rate. Since Wi-Fi™ networks are typically designed such that the target airtime utilization remains below 50-60%, these results demonstrate the ability of software application to perform well in a wide variety of network loading conditions. Except for the most extreme networks, the software application will perform with very low bit error. Table 1 illustrates different routers used for testing, with their Wi-Fi™ version and cost.

In some embodiments, the effect of the software application on network performance was also assessed. Because the software application is intended to be used on existing wireless networks, the protocol does not place a disproportionate load on the wireless network 100 or otherwise slow it down for other devices. We evaluate the effect of the software application on the device being pinged and the network utilization rate.

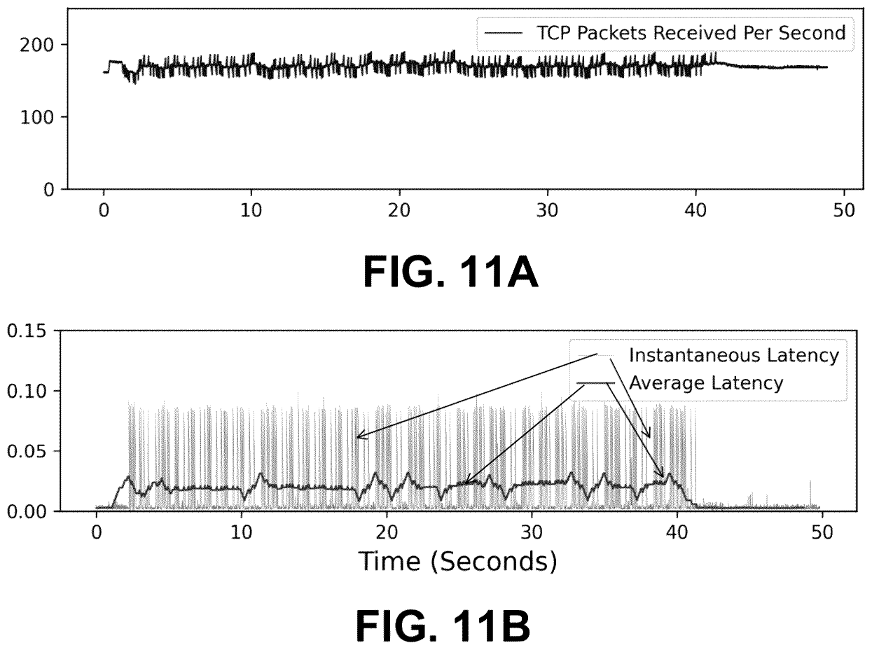

For example, we assess the effect on ping reflector network performance. FIG. 11A illustrates the average latency while FIG. 11B illustrates the total TCP packets received per second over the course of a single software application transmission. While the jamming by the software application transmitter increases the average latency by about 25 ms, it is noted that the number of TCP packets received per second remains the same during transmission and afterward. This highlights the fact that LSK causes only minor increase in latency, and the overall network performance of the ping reflector is not impacted in a way that would significantly degrade most applications.

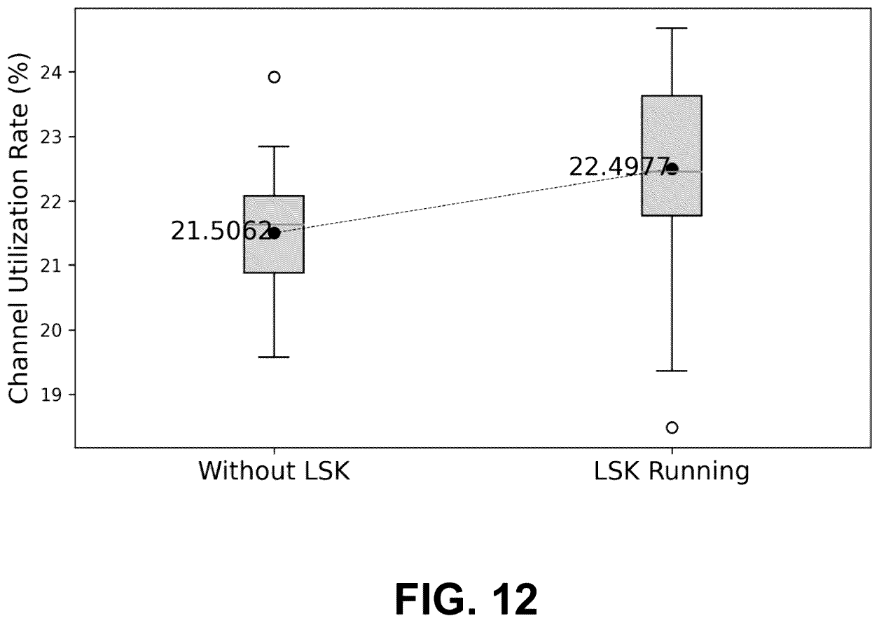

To evaluate the effect of the software application protocol on the utilization rate of a wireless network 100 as a whole, we compared the channel utilization rate measured on an idle network to that measured while a single device was transmitting. In both cases, the utilization rate reported by the AP was recorded over 45 seconds. The test results are illustrated in FIG. 12 and indicate that for a single transmitter/receiver running software application, the marginal network load is about 1%. This is not surprising, since the TCP packets are less than 60 bytes. Considering both the TCP SYN and RST/ACK packets, which are sent over the 2.4 GHz Wi-Fi™ network every 5 milliseconds, this only constitutes 0.192 Mbps of load placed on the network. While our utilization is potentially higher than most Wi-Fi™ sensors, the ability to protect a network from an untrustworthy sensor can be worth the cost of slightly extra utilization.

Because the software application is intended to be used in wireless applications, we also evaluated the effect of range between the transmitter device 105 and the anchor wireless device 110. For this evaluation, we assume that the ping reflector device 115 has been selected to have a solid and reliable connection to the access point.

Since in wireless communication, multi-path and line-of-sight obstructions can interfere with physical range measurements, the received signal strength as seen by the transmitter is used. The ESP32 transmitter is connected to a Raspberry Pi test device. The ESP32, upon receiving beacons from the access point, measures the RSSI and reports it to the Raspberry Pi, which sends it as an MQTT message to the test computer. For each test iteration, the transmitter is moved farther away from the AP, the RSSI as seen by the transmitter is logged, and the results are grouped by RSSI. The results are illustrated in FIG. 13, and indicate strong software application performance until an RSSI of about −60 dBm. It should be noted that upon inspection of the raw data, this appears to be about the point where the anchor wireless device 110 stops seeing the null frames sent by the ESP32. Given that the ESP32 continued to receive the beacon frames from the anchor wireless device 110 and report RSSI, it may be concluded that the drop-off in performance is likely caused by a limitation in transmit power on the transmitter.

To illustrated that the software application is viable for multiple IoT sensors on one wireless network, the test setup is expanded to support multiple transmitters running in parallel, communicating with a single receiver. FIG. 14 illustrates the BER of tests run with 1, 2, 3, and 4 devices transmitting simultaneously. We stop at four concurrent transmitters because of the lack of equipment to test more than four nodes. The results demonstrate consistently low BER even as additional concurrent transmissions are added. This is to be expected from the finding in that each transmission adds less than 1% to the network utilization rate. This evaluation validates the use of multiple transmitters and indicates that devices can be added to a software application network at minimal cost.

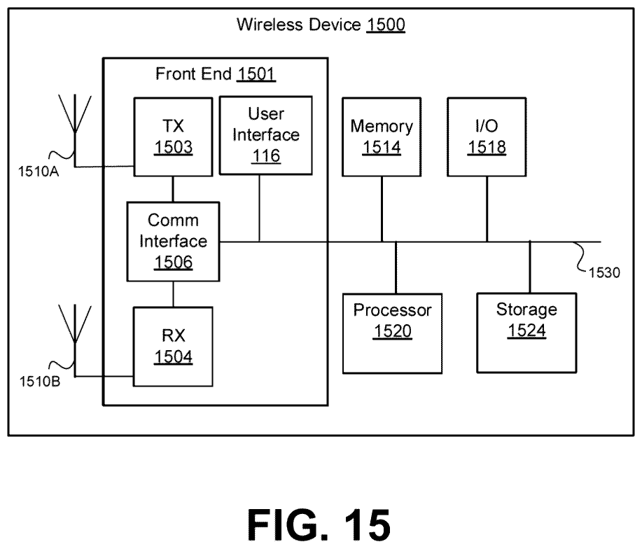

FIG. 15 is a schematic diagram of an example wireless device 1500, which can represent any of the wireless devices described herein according to various embodiments. For example, the wireless device 1500 can include the components and functionality of any of the wireless transmitter device 105, the receiver device 120, and the ping reflector device 115. In various embodiments, if the wireless device 1500 is the transmitter device 105, it could be an IoT device, which can be any low-power device that has limited operational capabilities of varying ranges based on how the IoT devices are powered and configured. Each IoT device can be understood to be a motion sensor (or other type of wireless sensor), a microprocessor-based transmitter that provides limited data on behalf of an appliance or machine, a smartphone, or other wireless communication device.

In at least some embodiments, the wireless device 1500 includes, but is not limited to, a front end 101 having a transmitter 103 or TX (e.g., a WLAN transmitter), a receiver 1504 or RX (e.g., a WLAN receiver), a communications interface 106, and a user interface 116. The wireless device 1500 may further include at least one TX antenna 1510A coupled to the transmitter 1503, and at least one RX antenna 1510B coupled to the receiver 1504. In some embodiments, at least the transmitter 1503 and the receiver 1504 form a transceiver of the wireless device 1500. In some embodiments, the front end 1501 includes switching circuitry to switch between dual bands, including for example, between two of the 2.4 GHz, 5 GHZ, and 6 GHz bands, although many IoT devices operate over a single frequency channel.

The wireless device 1500 may further include a memory 1514, one or more input/output (I/O) devices 1518 (such as a display screen, a touch screen, a keypad, and the like), a processor 1520, and a storage device 1524. These components can all be coupled to a communications bus 1530 or multiple communication buses. In some embodiments, at least some of the components of the wireless device 1500 are directly connected and may thus not be coupled through the communication bus 1530. Thus, illustration of the communication bus 1530 is not be taken as required or limiting for at least some of the components of the wireless device 1500, which may directly intercommunicate. In some embodiments, aspects of the communication interface 1506 work with the processor 1520 to perform operations or that function as a processing device of the wireless device 1500. In some embodiments, there is a single antenna and multiplexing logic to switch use of the antenna between the TX and RX.

In at least some embodiments, the memory 1514 and/or the storage device 1524 are computer-readable storage medium to store instructions executable by the processor 1520 and/or data generated or accessed by the communication interface 1506 or generated by the processor 1520. The processor 1520 can use the storage device 1524 during execution of program code, which can be stored in the memory 1514 that may or may not be the same memory components, depending on application and implementation. In various embodiments, frontend components such as the transmitter 1503, the receiver 1504, the communication interface 1506, and one or more antennas are adapted with or configured for WLAN and WLAN-based frequency bands, e.g., Wi-Fi®, Bluetooth® (BT), Bluetooth® Low Energy (LBE), Ultra-Wideband (UWB), LoRa™, Wi-SUN®, or other wireless protocol. While some of the wireless protocols may also be referred to as personal area network (PAN) technology, for simplicity, all are broadly referred to as WLAN technology. Future wireless protocols are also envisioned.

In various embodiments, the communication interface 1506 coordinates, as directed by the processor 1520, to request/receive packets from the other wireless devices or those that reflect off of objects. In embodiments, these can include channel state information (CSI) packets, ping packets, or ping acknowledgement packets, such as those discussed herein. The communications interface 1506 can further process data symbols received by the receiver 1504 in a way that the processor 1520 can perform further processing, including identifying and parsing data packets received within the wireless signals.

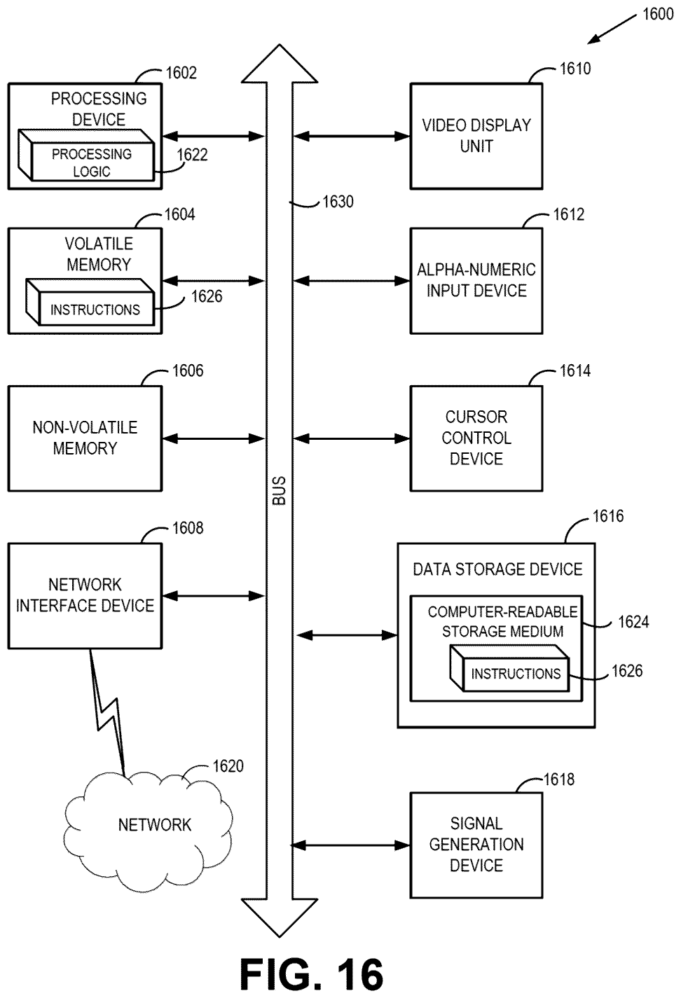

FIG. 16 is a block diagram illustrating an example computer system 1600, in accordance with implementations of the present disclosure. The computer system can be a computing device or other device discussed herein. The computer system 1600 can be the wireless transmitter device 105 or the receiver device 120 of FIG. 1 or FIG. 5, understanding that some IoT devices may be simpler and not include all of the displayed components. The computer system 1600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processing device 1602, a volatile memory 1604 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 1606 (e.g., flash memory, static random access memory (SRAM), etc.), and a data storage device 1616, which communicate with each other via a bus 1630.

The processing device 1602 represents one or more general-purpose processing devices such as a microprocessor, CPU, GPU, or the like. More particularly, the processing device 1602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 can also be one or more special-purpose processing devices such as an ASIC, a field programmable gate array (FPGA), a digital signal processor (DSP), network processor, or the like. The processing device 1602 is configured to execute instructions 1626 (e.g., for performing one or more of the method 200 or portions of the data flows 300, 400, or 500) for performing the operations discussed herein.

The computer system 1600 can further include a network interface device 1608. The network interface device 1608 can assist in data communication between computing devices. The computer system 1600 also can include a video display unit 1610 (e.g., a liquid crystal display (LCD) or a cathode ray tube (CRT)), an input device 1612 (e.g., a keyboard, and alphanumeric keyboard, a motion sensing input device, touch screen), a cursor control device 1614 (e.g., a mouse), and a signal generation device 1618 (e.g., a speaker).

The data storage device 1616 can include a non-transitory machine-readable storage medium 1624 (also computer-readable storage medium) in which is stored one or more sets of instructions 1626. The instructions may embody any one or more of the methodologies or functions described herein. The instructions 1626 can also reside, completely or at least partially, within the volatile memory 1604 and/or within the processing device 1602 during execution thereof by the computer system 1600, the volatile memory 1604 and the processing device 1602 also constituting machine-readable storage media. The instructions 1626 can further be transmitted or received over a network 1620 via the network interface device 1608.

In one implementation, the instructions 1626 include instructions for fine-grained traffic noise prediction. While the computer-readable storage medium 1624 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “displaying”, “moving”, “adjusting”, “replacing”, “determining”, “playing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the method 200 is depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the method could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A wireless network comprising:
a wireless transmitter device to:
multiply data bits with a spreading code to generate spread data;
prepend a synchronization word to the spread data; and
transmit a pair of null frames via an anchor wireless device to jam a ping reflector device for each chip of a one value within the synchronization word and the spread data; and
a receiver device to:
transmit, via the anchor wireless device, a plurality of ping packets to the ping reflector device at a particular ping rate;
receive ping acknowledgement packets from the ping reflector device in response to the transmitted plurality of ping packets, wherein each pair of null frames causes a spike in the ping acknowledgment packets that are received, and wherein the spike indicates receipt of a chip of the one value; and
in response to correlating the synchronization word within ones of the ping acknowledgment packets, begin use of the spreading code to decode the spread data encoded within subsequently received ones of the ping acknowledgement packets.

2. The wireless network of claim 1, wherein the wireless transmitter device is an untrusted Internet-of-Things (IoT) device on the wireless network, the receiver device is a trusted device on the wireless network, and wherein the receiver device connects to the anchor wireless device via one of a wired connection or a wireless connection.

3. The wireless network of claim 1, wherein the wireless transmitter device is further to:
monitor wireless packets for beacon frames from the anchor wireless device;
wait to detect a first beacon frame before transmitting a first null frame of the pair of null frames, wherein the first null frame signals to the anchor wireless device to buffer the plurality of ping packets received from the receiver device; and
transmit a second null frame of the pair of null frames before receipt of a second beacon frame following the first beacon frame, wherein the second null frame causes the anchor wireless device to transmit the buffered plurality of ping packets, causing the spike in the ping acknowledgement packets.

4. The wireless network of claim 1, wherein the synchronization word comprises a particular maximal length sequence (MLS) code, and the spreading code comprises a Barker code that provides a balance between autocorrelation and preserving data rate.

5. The wireless network of claim 1, further comprising the ping reflector device, which is a wireless device, wherein the plurality of ping packets that are transmitted comprise transport control protocol synchronize (TCP SYN) packets, and wherein the ping acknowledgement packets comprise a SYN acknowledgement if a destination port is open or a TCP reset packet if the destination port is closed on the ping reflector device.

6. The wireless network of claim 1, wherein the spreading code is a pseudo-random (PN) code, and wherein the wireless transmitter device is further to:
encode the data bits by multiplying the data bits by the PN code, wherein the multiplying comprises, for each data bit:
for a binary one, employ the PN code; and
for a binary zero, employ an inverse of the PN code;
transmit, for each chip of the one value within the encoded data bits, the pair of null frames to the anchor wireless device; and
transmit no packet for each chip of a zero value within the encoded data bits.

7. The wireless network of claim 1, wherein, to bootstrap communicating data between the transmitter wireless device and the receiver device:
the receiver device is to transmit a ping packet with a set of internet protocol (IP) addresses, a ping medium access control (MAC) address of the ping reflector device, and an identifying MAC address that uniquely identifies the receiver device and a latency shift keying (LSK) network;
the anchor wireless device is to:
insert, to the ping packet, an anchor MAC address of the anchor wireless device and transmit the ping packet to the ping reflector device; and
transmit a ping acknowledgment, responsive to the ping packet, to the receiver device; and
the transmitter wireless device is to:
detect that the ping acknowledgement packet comprises the identifying MAC address; and
extract, from the ping acknowledgement packet, a ping MAC address of the ping reflector device and the anchor MAC address for use in jamming the ping reflector device.

8. A receiver device operatively coupled to a wireless transmitter device through an anchor wireless device of a wireless network, the receiver device comprising:
a computer-readable storage medium storing instructions; and
a processing device configured to execute the instructions to perform operations comprising:
causing a plurality of ping packets to be transmitted, via the anchor wireless device, to a ping reflector device at a particular ping rate, wherein the ping reflector device is a wireless device of the wireless network other than the wireless transmitter;
causing ping acknowledgement packets to be received from the ping reflector device in response to the transmitted plurality of ping packets, wherein each pair of null frames transmitted by the anchor wireless device to jam the ping reflector device causes a spike in the ping acknowledgment packets that are received, and wherein the spike indicates receipt of a chip; and
in response to detecting a synchronization word within ones of the ping acknowledgment packets, beginning use of a spreading code to decode a spread data encoded within subsequently received ones of the ping acknowledgement packets.

9. The receiver device of claim 8, wherein the plurality of ping packets are transmitted as internet control message protocol (ICMP) requests and the ping acknowledgement packets are received as ICMP responses, and wherein the operations further comprise calculating round-trip time (RTT) based on a time elapsed being transmitting the ICMP requests and receiving the ICMP responses.

10. The receiver device of claim 8, wherein the plurality of ping packets that are transmitted comprise transport control protocol synchronize (TCP SYN) packets, and wherein the ping acknowledgement packets comprise a SYN acknowledgement if a destination port is open or a TCP reset packet if the destination port is closed on the ping reflector device.

11. The receiver device of claim 10, wherein the operations further comprise:
causing the plurality of ping packets to be transmitted in parallel with receiving the SYN acknowledgements;
inserting a random sequence number in each ping packet as an identifier; and
detecting the random sequence number plus a one value in each SYN acknowledgment in order to match each respective ping to a corresponding SYN acknowledgment.

12. The receiver device of claim 8, wherein the operations further comprise causing a ping packet, of the plurality of ping packets, to be transmitted comprising an identifying media access control (MAC) address in an Ethernet frame in lieu of a MAC address of the receiver device, wherein the identifying MAC address comprises a first identifier of the receiver device, a second identifier of a latency shift keying (LSK) network, and a field to indicate whether a channel associated with the ping reflector device is busy.

13. The receiver device of claim 8, wherein the spreading code is a pseudo-random (PN) code, and wherein the operations further comprise:
correlating spikes in the received ping acknowledgement packets with the synchronization word, wherein the synchronization word comprises a maximal length sequence (MLS) code; and
after detecting the MLS code, decoding the spread data by correlating spikes in the ping acknowledgement packets received after the synchronization word based on the PN code, wherein the PN code is shorter than the MLS code.

14. The receiver device of claim 13, wherein the operations further comprise:
tracking a number of ping acknowledgement packets received within each of a plurality of intervals;
determining a rolling variance across the number of ping acknowledgement packets in each interval of the plurality of intervals to generate smoothed variance data associated across the plurality of intervals;
correlating the smoothed variance data with the synchronization word within a first set of the ping acknowledgement packets to generate synchronization word correlation data;
determining that the synchronization word correlation data exceeds a threshold of two times a standard deviation of the smoothed variance data to confirm synchronization of the synchronization word; and
in response to determining that the synchronization word has synchronized to the smoothed variance data:
correlating, using the spreading code, the smoothed variance data to message payloads of the subsequently received ping acknowledgement packets to generate spreading code correlation data;
retrieving a sample from a plurality of samples of the spreading code correlation data at a frequency of beacon frames transmitted by the anchor wireless device; and
for each retrieved sample, determining a data bit as a one value when a correlation value is above zero and as a zero value when the correlation value is equal to or below zero.

15. A wireless transmitter device operatively coupled to a receiver device through an anchor wireless device of a wireless network, the wireless transmitter device comprising:
a computer-readable storage medium storing instructions; and
a processing device configured to execute the instructions to perform operations comprising:
multiplying data bits with a spreading code to generate spread data;
prepending a synchronization word to the spread data; and
transmitting a pair of null frames via the anchor wireless device to jam a ping reflector device for each chip of a one value within the synchronization word and the spread data, wherein the ping reflector device is a wireless device of the wireless network other than the receiver device.

16. The wireless transmitter device of claim 15, wherein, to bootstrap interaction with the ping reflector device, the operations further comprise:
monitoring for ping packets with an identifying medium access control (MAC) address;
detecting a frame in a ping packet, received from the receiver device, comprising the identifying MAC address; and
identifying, from the ping packet, a ping MAC address of the ping reflector device and an anchor MAC address of the anchor wireless device for use in transmitting the null frames to the anchor wireless device, wherein the null frames are for use in jamming the ping reflector device.

17. The wireless transmitter device of claim 15, wherein the spreading code is a pseudo-random (PN) code, and wherein the operations further comprise:
encoding the data bits by multiplying the data bits by the PN code, wherein the multiplying comprises, for each data bit:
for a binary one, employ the PN code; and
for a binary zero, employ an inverse of the PN code;
transmitting, for each chip of the one value within the encoded data bits, the pair of null frames to the anchor wireless device; and
transmitting no packet for each chip of a zero value within the encoded data bits.

18. The wireless transmitter device of claim 15, wherein the operations further comprise:
monitoring wireless packets for beacon frames from the anchor wireless device;
waiting to detect a first beacon frame before transmitting a first null frame of the pair of null frames, wherein the first null frame is to signal to the anchor wireless device to buffer a plurality of ping packets received from the receiver device; and
transmitting a second null frame of the pair of null frames before receipt of a second beacon frame following the first beacon frame, wherein the second null frame causes the anchor wireless device to transmit the buffered plurality of ping packets, causing a spike in ping acknowledgement packets received by the receiver device.

19. The wireless transmitter device of claim 15, wherein the operations further comprise:
initiating a state machine in response to reception of each beacon frame from the anchor wireless device;
initiating a timer to a time period between beacon frames; and
iterating through the state machine depending on chip values within the synchronization word and the spread data, wherein the iterating comprises:
for a one chip value:
transmitting a first null frame of the pair of null frames, triggering the anchor wireless device to buffer ping packets transmitted by the receiver device;
delaying, based on a value of the timer, a particular delay period that is less than the time period;
transmitting a second null frame of the pair of null frames, triggering the anchor wireless device to transmit the buffered ping packets to the ping reflector device; and
incrementing a chip pointer to a next chip value; and
for a zero chip value:
incrementing the chip pointer to the next chip value; and
waiting for a next iteration of the state machine.

20. The wireless transmitter device of claim 15, wherein the synchronization word comprises a particular maximal length sequence (MLS) code, and the spreading code comprises a Barker code that provides a balance between autocorrelation and preserving data rate.
